(19) United States
(12) Patent Application Publication
(10) Pub. No.: US 2018/0219512 A1
(43) Pub. Date: Aug. 2, 2018

(54) IRREGULAR PHOTOVOLTAIC ROOFING SYSTEM WITH A FLASHING PIECE

(71) Applicant: Dow Global Technologies LLC, Midland, MI (US)

(72) Inventors: Joseph A. Langmaid, Caro, MI (US); Leonardo C. Lopez, Midland, MI (US); Gerald K. Eurich, Merrill, MI (US)

(21) Appl. No.: 15/745,673

(22) PCT Filed: Jul. 1, 2016
(86) PCT No.: PCT/US2016/040607

§ 371 Date: Jan. 17, 2018

Related U.S. Application Data
(60) Provisional application No. 62/194,440, filed on Jul. 20, 2015.

(51) Int. Cl. H02S 99/00; G09F 3/00

(52) U.S. Cl. CPC H02S 99/00; H02S 20/23; G09F 3/00

(57) ABSTRACT

A photovoltaic array comprising: three or more overlapping rows of photovoltaic modules wherein at alternating ends, adjacent rows of photovoltaic modules are interconnected by a row-to-row flashing piece wherein a first row of photovoltaic modules extend a distance beyond a second row of photovoltaic modules and a third row of photovoltaic modules and the second row of photovoltaic modules is in communication with one or more flashing components that extend the second row of photovoltaic modules at least the distance that the first row of photovoltaic modules extend.

### FIELD

The present teachings generally relate to an improved photovoltaic roofing system that connects directly to a building structure and is irregularly shaped to accommodate one or more features of the building structure.

### BACKGROUND

Typically, photovoltaic arrays are placed in an elevated location such as a roof top of a home or a building or in a rack and frame that elevates the photovoltaic array so that the photovoltaic array is exposed to sunlight. The roofs on homes and/or buildings generally are formed by adding a plurality of pieces of panels together so that a generally contiguous surface is formed, which are supported by one or more trusses. Photovoltaic modules may be secured to the plurality of pieces of panels directly and/or indirectly via a connection structure such as a rack and frame. Each photovoltaic module of the photovoltaic array may include only an active portion and the active portions of two or more photovoltaic modules may be placed in close proximity with one another so that a photovoltaic array is formed over and/or on the connection structure. However, in cases where the photovoltaic modules provide roofing functions (i.e. building integrated photovoltaic or BIPV), the photovoltaic modules may include both an active portion and a support portion and the active portion of one photovoltaic module may fully and/or partially cover the support portion of an adjacent photovoltaic module to replace the framing and racking structure. Further, the active portion and the support portion are one integrally formed piece with the photovoltaic active portion located within the active portion so that in order to remove the photovoltaic active portion the entire photovoltaic module would be removed and replaced if necessary. In cases of building integrated photovoltaics, the building may include structures such as a vent, chimney hip roof, dormer, or other roof obstacles that prohibits the photovoltaic array from forming a symmetrical structure due to the structures. Attempts have been made to accommodate the structures.

Examples of some photovoltaic modules and photovoltaic arrays that accommodate structures may be found in U.S. Pat. Nos. 8,631,614; and 8,898,970 U.S. Patent Application Publication No. 2008/0302030; 2010/0146878; 2010/0180523; 2012/0118349; and 2014/0165480; and International Patent Application Nos. WO2011/019886 and WO2013/019628 all of which are incorporated by reference herein for all purposes.

It would be attractive to have a system that interfaces the photovoltaic array and standard roofing shingles and accommodates for roof structures so that a water tight seal is created between the photovoltaic array and standard roofing shingles. It would be attractive to have flashing pieces that step a portion of the photovoltaic array to the left or to the right. What is needed is a system that resists windup lift while preventing fluid penetration into the photovoltaic array while accommodating the roof structures. What is needed is a series of self-interlocking photovoltaic array components that lock together and form a fluid tight structure without the need for additional sealing material while forming an irregularly shaped photovoltaic array.

### SUMMARY

The present teachings provide: a photovoltaic array comprising: three or more overlapping rows of photovoltaic modules wherein at alternating ends, adjacent rows of photovoltaic modules are interconnected by a row-to-row flashing piece wherein a first row of photovoltaic modules extend a distance beyond a second row of photovoltaic modules and a third row of photovoltaic modules and the second row of photovoltaic modules is in communication with one or more flashing components that extend the second row of photovoltaic modules at least the distance that the first row of photovoltaic modules extend.

The present teachings provide: an irregular photovoltaic array comprising: (a) three or more rows of photovoltaic modules; and (b) at least one step-in, at least one step-out, or both that include: (i) one or more flashing components; and (ii) one or more row-to-row flashing pieces; wherein the one or more flashing components are in communication with and connected to the one or more row-to-row flashing pieces or one or more photovoltaic modules of the three or more rows of photovoltaic modules; wherein one or more rows of the three or more rows of photovoltaic modules extends beyond one of the one or more row-to-row flashing pieces and a second row of the three or more rows of photovoltaic modules terminates at the one or more row-to-row flashing pieces so that a space is created on one side of the photovoltaic array between the one row and the second row where no photovoltaic components are present.

The present teachings provide: a method for forming the array of the teachings herein: (a) forming one or more rows of photovoltaic modules and including at least one row of photovoltaic modules that are in direct contact with and overlap the starter row; (b) terminating at least one of the one or more rows of photovoltaic modules with a row-to-row connector; (c) overlapping the row-to-row connector on an inside edge at least partially with a photovoltaic component of the one or more rows; (d) connecting a flashing component to the row-to-row connector on an outside edge so that the flashing component extends beyond the starter row of flashing components; and (e) applying one or more rows of stepped out photovoltaic modules that have a portion that extends over the flashing component that extends beyond the starter row of flashing components so that the at least a portion of the one or more rows of stepped out photovoltaic modules extend beyond the starter row.

The present teachings provide: a method for forming the array of the teachings herein: (a) forming one or more rows of photovoltaic modules; (b) capping a portion of a top row of the one or more rows of photovoltaic modules; and (c) applying one or more stepped in rows of photovoltaic modules over the top row of the one or more rows of photovoltaic modules and terminating the stepped in rows of photovoltaic modules at the portion of the top row that is capped so that a space of photovoltaic components is formed above the partial capped portion of the one or more rows of photovoltaic modules.

The present teachings provide: a method comprising: forming a first row of interconnected photovoltaic modules on a roof, each module having an active portion and a support portion and two side edges, forming a second row of interconnected photovoltaic modules on a roof each module having an active portion and a support portion and two side edges, wherein the second row is applied such that at least part of the active portion for the second row of interconnected photovoltaic modules overlaps with at least a part of the support portion of the first row of interconnected photovoltaic modules and wherein the edges of the photovoltaic modules of the first and second rows are offset, forming a third row of interconnected photovoltaic modules on a roof each module having an active portion and a support portion and two side edges, wherein the third row is applied such that at least part of the active portion for the third row of interconnected photovoltaic modules overlaps with at least a part of the support portion of the second row of interconnected photovoltaic modules and wherein the edges of the photovoltaic modules of the third and second rows are offset, wherein one of the first or third rows forms a step in or a step out that is an extended row extending a distance beyond both of the other rows, on one end of the second row connecting one or more flashing pieces which extend the second row the distance of the extended row, connecting the first and second rows using a row-to-row flashing piece on a first end and connecting the second and third rows using a row-to-row flashing piece on a second end.

The teachings herein surprisingly solve one or more of these problems by providing a system that interfaces the photovoltaic array and standard roofing shingles and accommodates for roof structures so that a water tight seal is created between the photovoltaic array and standard roofing shingles. The present teachings provide flashing pieces that steps a portion the photovoltaic array to the left or to the right. The present teachings provide a system that resists wind uplift while preventing fluid penetration into the photovoltaic array while accommodating the roof structures. The present teachings provide a series of self-interlocking photovoltaic array components that lock together and form a fluid tight structure without the need for additional sealing material while forming an irregularly shaped photovoltaic array.

### BRIEF DESCRIPTION OF THE DRAWINGS

FIG. 1 illustrates a top perspective view of a photovoltaic array;

FIG. 2 illustrates partial cross-sectional view of the photovoltaic array of FIG. 1;

FIG. 3 illustrates a bottom view of connection members mated together;

FIG. 4 illustrates a close-up cross-sectional view of two overlapped photovoltaic modules and the connection members mated together of FIG. 2;

FIG. 5 illustrates an exploded view of the photovoltaic array of FIG. 1;

FIG. 6 is a plan view of an irregular photovoltaic array with a step-in and a step-out;

FIG. 6A is a close-up plan view of a step-in right of FIG. 6;

FIG. 6B is an exploded view of the components of the step-in right of FIG. 6A;

FIG. 7 is a plan view of a step-out left of FIG. 6;

FIG. 7A is an exploded view of the components of the step-out left of FIG. 7;

FIG. 8 is a perspective view of a bottom piece;

FIG. 8A is a plan view of a photovoltaic module including a cut on a right side;

FIG. 8B is a plan view of a photovoltaic module including a cut on a left side;

FIG. 9 is a perspective view of a bottom right plus piece;

FIG. 9A is a plan view of a bottom right plus piece including a cut;

FIG. 10 is a perspective view of a bottom left plus piece;

FIG. 10A is a plan view of a bottom left plus piece including a cut;

FIG. 11 is a top perspective view of a top right plus piece;

FIG. 11A is a bottom view showing an alignment slot;

FIG. 12 is a top perspective view of a top right minus piece;

FIG. 13 is a top perspective view of a bottom left minus piece;

FIG. 14 is a top perspective view of a bottom right minus piece;

FIG. 15 is a top perspective view of a left piece;

FIG. 15A is a close-up view of a row-to-row connector portion;

FIG. 16 illustrates a top of a cap;

FIG. 17 is a bottom view of a cap;

FIG. 18 is a perspective view of a top piece;

FIG. 19 is a perspective view of a top left minus piece;

FIG. 20 is a perspective view of a top left plus piece;

FIG. 21 is a perspective view of a step-in right piece;

FIG. 22 is a perspective view of a step-in left piece;

FIG. 23 is a perceptive view of a photovoltaic module; and

FIG. 24 is a perspective view of a right piece (row-to-row).

### DETAILED DESCRIPTION

The explanations and illustrations presented herein are intended to acquaint others skilled in the art with the teachings, its principles, and its practical application. Those skilled in the art may adapt and apply the teachings in its numerous forms, as may be best suited to the requirements of a particular use. Accordingly, the specific embodiments of the present teachings as set forth are not intended as being exhaustive or limiting of the teachings.

A plurality of photovoltaic components (e.g., photovoltaic modules (i.e., active components) and flashing components) of the teachings herein are combined together to form a photovoltaic array. The photovoltaic array collects sunlight and converts the sunlight to electricity. Preferably, the photovoltaic array taught herein is free of a separate structure that houses all of the photovoltaic components that make up a photovoltaic array (also referred to as a solar array). More preferably, each individual photovoltaic component may be connected directly to a structure and provides cladding to the structure (i.e., is a building integrated photovoltaic (BIPV)) and each of the individual photovoltaic components is electrically connected together so that a photovoltaic array is formed. The photovoltaic components may be connected to a support structure that forms a connection surface.

The connection surface functions to provide support to one or more photovoltaic components so that a photovoltaic array is formed. Preferably, the connection surface is a roof. The roof may be made of any material that has sufficient strength to support the weight of the plurality of photovoltaic modules and to which plurality of photovoltaic modules can directly connected. Alternately, the connection surface may be a series of structural components which do not form a continuous roof surface, such as in the case of a batten type roof structure. The plurality of photovoltaic components are connected to the connection surface so that the photovoltaic components are adjacent to one another. For example, an edge of one photovoltaic components may be located substantially proximate to an edge of an adjoining photovoltaic components. Preferably, the photovoltaic components partially overlap each other. For example, the active portion and/or a support portion of one photovoltaic module may overlap an overlap portion of one or more adjacent photovoltaic modules in a similar fashion to how roofing shingles are applied to a roof. Preferably, the photovoltaic module includes a base plate and a support portion of the base plate of one photovoltaic module may extend at least partially over an overlap portion of an adjacent base plate.

The photovoltaic components are aligned in rows (e.g., horizontally) or columns (e.g., vertically), but as discussed herein both rows and columns will be referred to as rows. The photovoltaic array may include three or more rows, four or more rows, five or more rows, or even six or more rows. The combination of rows of photovoltaic components when connected together form a photovoltaic array that includes a peripheral edge. The peripheral edge is the outer edge that extends around an outer most region of the photovoltaic array. Each of the rows has two ends, and adjacent rows have ends connected with alternating adjacent rows (i.e., alternating ends). For example, a left end of a first row and a second row are connected and right end of a second row and a third row are connected by row-to-row flashing pieces so that alternating ends are connected forming a serpentine configuration. Generally, the photovoltaic modules are staggered from row-to-row such that they overlap a portion of two or more lower photovoltaic components. Preferably each of the overlapped photovoltaic components has a portion that extends outside of the overlapping photovoltaic component. Each of the photovoltaic components either overlaps one or more adjacent photovoltaic components, is overlapped by one or more adjacent photovoltaic components, or both overlaps and is overlapped by one or more adjacent photovoltaic components. The overlap may form a double overlap so that each of the photovoltaic components is covered forming a shingle effect. The active components and the flashing components may connect together in an overlapped fashion forming the photovoltaic array as set forth herein.

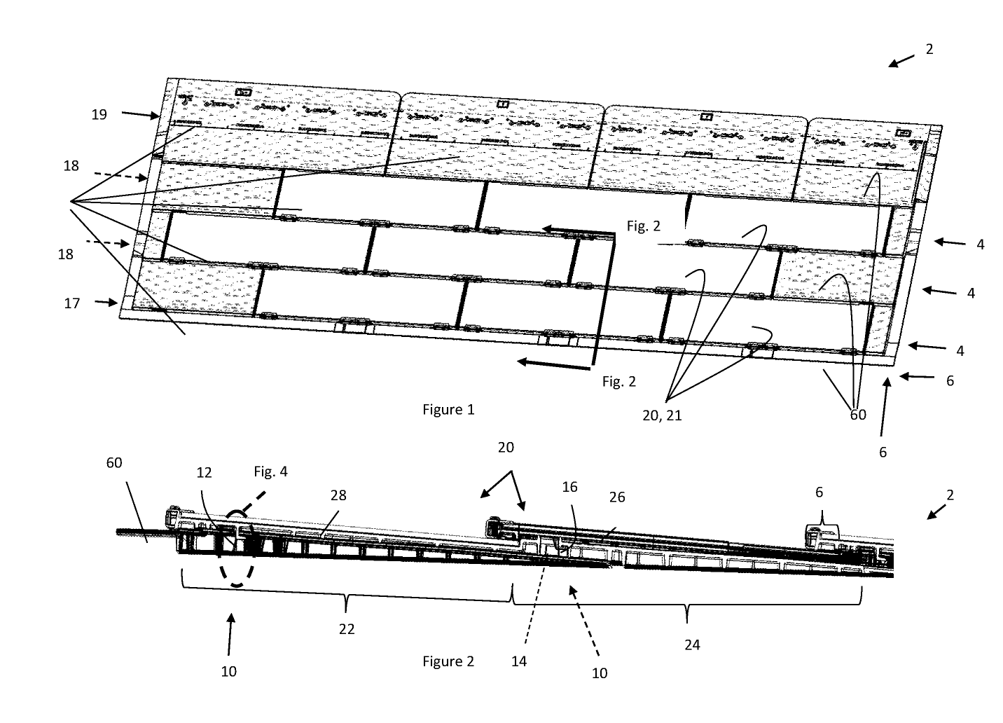

Preferably, the shingle effect is such that each row contains photovoltaic modules having an active portion in which electricity is generated upon exposure to light and an inactive portion. The active portion overlaps the inactive portion of the previous row. In addition, the modules are staggered such that the edge of each module in a row is offset from the edge of the overlapping module in an adjacent row. An example of this can be seen in FIG. 1. This staggering prevents there from being any direct path for water to go between the shingles to the roof or other mounting surface. However, in some situations due to features on the roof or other structure on which the array is mounted, one or more rows in the array may need to extend further than adjacent rows by a distance further than the standard stagger distance. When a lower (e.g. towards the bottom edge of the roof) row extends beyond the distance of upper (e.g. towards the top of the roof) row(s), that is referred to herein as a step in, since the array generally assembled from the lower rows to the upper rows. When an upper row extends beyond the distance of a lower row that is referred to herein as a step-out.

Each of the photovoltaic components function to form a portion of the photovoltaic array that prevents the ingress of water. Each of the photovoltaic components serves a roofing function. The photovoltaic components each include a surface that deflects water from the roofing structure and/or prevents water from penetrating into the photovoltaic array.

The photovoltaic modules include an active portion and an inactive portion. Those portions may be integral with each other or they may be in the form of separate pieces which are connected. In the latter situation, there may be a support portion underlying the active portion which is integral with the inactive portion. In such an embodiment the support portion may be called a base plate. The active portion (e.g. a photovoltaic laminate) may be any portion of the photovoltaic module that produces electricity when the active portion is in contact with sunlight. The active portion may be made of any material so that when sunlight is directed on the active portion the sunlight is converted into electricity. The active portion may be made of one or more photovoltaic cells having a photoactive portion. Preferably, the active portion may be made of a plurality of photovoltaic cells. The photovoltaic cells may be of any type and material known in the art. Some non-limiting examples of materials that the photovoltaic cells may be made of include crystalline silicon, amorphous silicon, cadmium telluride (CdTe), gallium arsenide (GaAs), copper chalcogenide type cells (e.g. copper gallium selenides, copper indium gallium selenides (CIGS), copper indium selenides, copper indium gallium sulfides, copper indium sulfides (CIS), copper indium gallium selenide sulfides, etc. (i.e., known generally as CIGSS)), thin-film III-V cells, thin-film II-VI cells, IB-IIIA-chalcogenide (e.g., IB-IIIA-selenides, IB-IIIA-sulfides, or IB-IIIA-selenide sulfides), organic photovoltaics, nanoparticle photovoltaics, dye sensitized photovoltaic cells, and/or combinations of the described materials. In one specific example, the copper indium gallium selenides may be represented by the formula Culn(1-x)GaxSe(2-y)Sy where x is 0 to 1 and y is 0 to 2. For copper chalcogenide type cells, additional electroactive layers such as one or more of emitter (buffer) layers, conductive layers (e.g. transparent conductive layers) or the like maybe used in CIGSS based photovoltaic cells are contemplated by the teachings herein. The active portion may be flexible or rigid and come in a variety of shapes and sizes, but generally are fragile and subject to environmental degradation. In a preferred embodiment, the active portion is a cell that can bend without substantial cracking and/or without significant loss of functionality. Other materials and/or combinations are contemplated herein especially those compositions disclosed in paragraph 0054 of U.S. Patent Application Publication No. 2012/0118349, which is incorporated herein by reference as to materials for the active portion. The photovoltaic cells of the photovoltaic laminate may be arranged in parallel, series, mixed series-parallel, and/or may be provided in independent circuits. The photovoltaic laminate may be a combination of layers and may form an assembly.

The active portion or pv laminate assembly may include one or more of the following components: a forward protective layer, a rearward protective layer, a reinforcement, a photovoltaic cell, a peripheral moisture sensitive edge seal, one or more internal protecting layers, dielectric materials as may be needed to manage the penetration of electrical components outside the laminate, attached connectors and wiring boxes, connector support structures including junction boxes, integrated low profile connectors, encapsulants, moisture resistant back sheets that may optionally include metallized sub layers, or a combination thereof. One example of a active portion may include a top layer of glass or a polymeric moisture barrier, an encapsulant layer, an electrical assembly comprising cells, bypass diodes and busses, a rear encapsulant layer, an aluminum based multi-layer back sheet, another encapsulant layer, a rearward protective layer, additional layers around the connector area including a connector support structure, an encapsulant, a dielectric layer, a connector sealant material such as an adhesive with a moisture barrier or another adhesive sealant or potting material, the low profile connector attached to the cells with bus terminals, another layer of encapsulant, and another dielectric layer. The rearward protective layer may help protect the laminate from any protrusions or abrasion from the support structure of the base plate. One or more of the layers discussed herein may be a combination of layers. For example, a forward protective layer may be a combination of multiple glass layers combined together. As another example, the reinforcement may be a plurality of layers bonded together. The layers of the active portion or pv laminate assembly may be laminated together. The layers of the pv laminate may be sealed at the edges. Preferably, the pv laminate has a peripheral sealed edge that is resistant to fluid penetration. As discussed herein, each individual layer may include an adhesive so that one or more layers are bonded together forming a layer, each layer may include an adhesive over and/or under another layer so that the one or more adjacent layers are bonded together. Other components and layers of the photovoltaic module are contemplated herein that may be used with the reinforcement taught herein especially those components, layers, and/or materials disclosed in Paragraph Nos. 0048-0053 of U.S. Patent Application Publication No. 2012/0118349, and Paragraph Nos. 0027-0038 and FIGS. 2A and 2B 2011/0220183, both of which are expressly incorporated herein by reference as to components, layers, and/or materials for active portions that may be used in conjunction with the reinforcement and photovoltaic module discussed herein. One or more of the layers of the pv laminate may be electrical circuitry. The electrical circuitry may be sealed within the pv laminate.

The electrical circuitry which preferably are included in the photovoltaic module and in some instances included directly in the photovoltaic laminate may include one or more buss bars, one or more ribbons, or both. The electrical circuitry may extend from cell to cell, photovoltaic module to photovoltaic module, cell to a photovoltaic module, active portion to active portion, or a combination thereof. The electrical circuitry may be integrated into the one or more photovoltaic cells, connect the one or more photovoltaic cells, be electrically connected to the one or more photovoltaic cells, or a combination thereof. The electrical circuitry may be integrated into and/or around one or more layers of the photovoltaic laminate. The electrical circuitry may extend through the photovoltaic laminate, extend partially outside of the photovoltaic laminate so that an electrical connection may be formed, have a portion that is located adjacent to the photovoltaic laminate, or a combination thereof. The photovoltaic laminate may be connected to a support portion of a base plate forming an adjacent portion. The pv laminate may include one or more connectors that are part of the electrical circuity and extend outside of the pv laminate. The one or more connectors may have a portion that is sealed within the pv laminate and a portion that extends out of the pv laminate. The one or more connectors may be covered by one or more active components, one or more flashing components, or both.

Each photovoltaic component is preferably connectable to one or more adjacent photovoltaic components so that a water tight seal is formed. Each of the photovoltaic components include a peripheral edge. The peripheral edge is an edge that extends about a perimeter of each photovoltaic component. The peripheral edge may include one or more top edges, one or more side edges, one or more bottom edges, or a combination thereof. The peripheral edge may be free of any connection members. The peripheral edge may overhang any connection members of the photovoltaic components. The connection member may be located about 1 cm or more, about 2 cm or more, or about 3 cm or more from the closest peripheral edge, any peripheral edge, every peripheral edge, or a combination thereof. The connection member may be located about 50 cm or less, about 40 cm or less, even about 35 cm or less, about 20 cm or less, or about 12 cm or less from a closest peripheral edge, any peripheral edge, every peripheral edge, or a combination thereof. For example, the connection member may be located 5 cm or more from a bottom edge, 10 cm or more from a top edge, 5 cm or more from a first side edge, and 25 cm or more from a second side edge. The peripheral edge may overhang the connection members so that during installation the installation is a “blind” installation. The connection member's may be located in a central region of the photovoltaic components.

The connection members function to connect two or more photovoltaic components together and preferably prevent fluid from passing through the photovoltaic array. Two or more connection members connect together in a mating region where the photovoltaic components overlap and connect together, where the connection members form a complementary fit together and/or where two or more connection members align to connect two or more photovoltaic components together. The two or more connection members may extend in the direction of the slope of the support structure (e.g., vertically), perpendicular to the direction of the support structure (e.g., horizontally, or a direction between horizontal and vertical. The connection members may prevent wind uplift. The connection members may be a male and female component. The connections members may be a connection hook, a connection recess, or both. Each photovoltaic component includes at least one connection member. Each photovoltaic component may include a plurality of connection members. Some photovoltaic components may include only a connection hook or only a connection recess. Some photovoltaic components include both connection hooks and connection recesses.

The one or more connection recesses may function to connect two or more adjacent photovoltaic components, two or more adjacent base plates, two or more photovoltaic modules, two or more flashing components, two or more active components, a flashing component and an active component, or a combination thereof together. The one or more connection recesses may extend along a width of the photovoltaic component. The one or more connection recesses may extend transverse to the slope of the roof. The one or more connection recesses may be spaced apart along the photovoltaic component so that the connection recesses may receive a portion of two or more adjacent photovoltaic components (e.g., a connection hook). The one or more connection recesses may be located along edges but inside of the edge, in edge regions, in a central region, or a combination thereof of the photovoltaic components. Preferably the connection recesses are evenly spaced out across the base plate, the photovoltaic module, or both. The photovoltaic components may include zero, two or more, three or more, four or more, or even five or more connection recesses, connection hooks, or both. The one or more connection recesses may be a through hole that extends through the photovoltaic component (e.g., flashing component or base plate). The one or more connection recesses may be any shape that may receive a portion of an adjacent photovoltaic component so that the photovoltaic components are locked relative to each other, movement relative to each other is prevented, or both. The one or more connection recesses may include one or more walls that create a border around the connection recesses.

The one or more walls may function to support an adjacent photovoltaic module above the connection recess. The one or more walls may function to prevent fluid from entering into the connection recess. The one or more walls may be an elevated surface that extends from the base plate proximate to the connection recesses. The walls may extend sufficiently high so that the walls contact a bottom side of an adjacent photovoltaic component and the bottom side acts as a lid. The walls may be a plurality of walls that extend around a connection recess. The walls may be a single wall that extends about a periphery of the connection recess. A single wall may extend around two or more, three or more, or even four or more connection recesses. The walls may be one unitary structure that extends from the photovoltaic component. The walls may assist in creating a fixed connection with an adjacent photovoltaic module. The walls may assist in placing two adjacent photovoltaic components in tension. The one or more connection recesses may receive one or more connection hooks in a mating region and the walls of the connection recesses may contact an underside of the overlapping photovoltaic component in the mating region forming a water tight connection.

The one or more connection hooks may function to prevent movement (e.g., vertical, horizontal, longitudinal, diagonal, or a combination thereof) of two or more photovoltaic components, two or more photovoltaic modules, two or more active components, two or more flashing components, at least one flashing component and at least one active component, or a combination thereof relative to each other. The one or more connection hooks may prevent wind uplift. The one or more connection hooks may extend into a connection recess. The photovoltaic components may include an equal number of connection hooks and connection recesses. The one or more connection hooks may extend through a connection recess. The one or more connection hooks may contact a portion of the connection recess, an area adjacent to the connection recess, a rear side of the photovoltaic components, the photovoltaic module, a rib, or a combination thereof. The one or more connection hooks may extend through the connection recess and then turn and contact a portion of the photovoltaic components, an opposing side, an internal wall, or a combination thereof. The one or more connection hooks may extend into the connection recess and contact a portion of the inside of the connection recess. The one or more connection hooks may be smaller than the connection recess. A gap may be located on one or both sides, one or both edges, or both of the connection hooks. The one or more gaps may allow the connection hooks to extend into the connection recess without being completely aligned. The gaps may be sufficiently large so that the connection hooks can move side to side in the connection recess during formation of a connection. The one or more gaps may be about 1 mm or more, 2 mm or more, 3 mm or more, or even about 5 mm or more. The one or more gaps may be about 5 cm or less, preferably about 4 cm or less, more preferably about 3 cm or less, or even more preferably about 2 cm or less. The one or more connection hooks may extend into the connection recess and into contact with a rib or wall that puts tension of the connection hook so that the photovoltaic component is prevented from lifting. The one or more connection hooks may be located along edges but inside of the edge, in edge regions, in a central region, or a combination thereof of the base plate. The photovoltaic components may include two or more, three or more, four or more, or even five or more connection hooks.

The one or more connection hooks may have a portion that extends in the direction of the slope of the connection structure (i.e., vertically), opposite the slope of the connection structure, perpendicular to the direction of the slope (i.e., horizontally) of the connection structure, or a combination thereof. The one or more connection hooks may extend from a rear side the photovoltaic components. The one or more connection hooks may include one or more lock features. The one or more lock features may form a fixed connection with a connection recess, a rib, a wall, or a combination thereof. The one or more lock features may function to provide an indication that a lock is formed. The one or more lock features may function to provide resistance when detaching the connection hook from the connection recess. The one or more connection members may be located proximate to one or more fastener supports.

The fastener supports may be located within the active portion, the overlap portion, the support portion, cap portion, in the photovoltaic components, or a combination thereof. Preferably, the fastener supports may be located within the overlap portion. The fastener supports may be a through hole that extends through the overlap portion, a weakened area so that a fastener may be placed through the fastener support, a removable portion, a punch out, an area of lower hardness, or a combination thereof. Preferably, the fastener supports may be a region where the photovoltaic components are reinforced so that fasteners may extend through and connect the photovoltaic component to the one or more connection surfaces and the fasteners do not damage the photovoltaic laminate when the photovoltaic component, the overlap portion, or both is subjected to movement. The one or more fastener supports may accept one or more fasteners.

The plurality of photovoltaic components may be connected to the connection surface by any fastener that has sufficient strength to withstand environmental conditions and form a secure connection. The plurality of photovoltaic components may be connected to a connection surface with a mechanical fastener, an adhesive, an interlocking connection with an adjacent photovoltaic module, or a combination thereof. The fasteners may be a screw, nail, bolt, staple, rivet, or a combination thereof. The adhesive may be any adhesive with sufficient strength to connect the photovoltaic components to the connection surface. The adhesive may be epoxy based, silicone based, acrylic based, a urethane based, a polyamide based, a one part adhesive, a multi-part adhesive, a natural adhesive, a synthetic adhesive, a butyl rubber, a polyolefin based adhesive, or a mixture thereof. The connection may be a permanent connection, a removable connection, or both so that photovoltaic components are connected to a connection surface. The photovoltaic components may be lightweight and have a low profile so that the photovoltaic components may be connected directly to the connection surface by the fastener supports, the alternative fastener supports, or both as are discussed herein. The one or more fastener supports may be located outside of the connector channels so that connectors may extend into and be removed from the connector channels.

The one or more handles may function to provide a carrying location for the photovoltaic components. The one or more handles may function to provide a location to lift the photovoltaic components. The one or more handles may be a through hole through the photovoltaic components (e.g., photovoltaic module, base plate, flashing components). The one or more handles may assist in forming a connection between two or more adjacent photovoltaic components. The one or more handles may align with another structure of one or more adjacent photovoltaic components. The one or more handles may extend through one or more ribs. The one or more handles as taught herein may include teachings from U.S. Provisional Patent Application No. 61/856,125, filed on Jul. 19, 2013 the teachings of which are expressly incorporated by reference herein in their entirety and especially the teachings of paragraph nos. 0029 to 0057 and FIGS. 1-10C as to the mating features, male component, female component, through hole, and projection. The handles may be located in an overlap portion.

The overlap portion may function to receive a portion of one or more photovoltaic components. The overlap portion may function to provide support to one or more photovoltaic components. The overlap portion may be covered by a photovoltaic module, a photovoltaic component, a flashing component, or a combination thereof. The overlap portion may be directly connected to a support structure. The overlap portion may include one or more connection recesses. The overlap portion may be adjacent one or more active portions, support portion, cap portions, or a combination thereof. The active portion and the support portion may be part of the photovoltaic module as discussed herein and the cap portion may be part of the flashing component as discussed herein. The one or more photovoltaic components may include a portion that is made of a polymeric composition and the polymeric composition may include the handles, ribs, or both.

The polymeric composition of the photovoltaic components (e.g., the polymeric components of the photovoltaic module and flashing components) preferably have low shrinkage, result in a uniform elastic modulus between a length and width, or a combination of both. The polymeric composition may be any polymeric composition that may be flowable, have high electrical insulating properties, fluid impermeable, high flexibility, low creep, low modulus, fire retardant, or a combination thereof. Some polymeric compositions that may be used with the photovoltaic module taught herein are an elastomer, thermopolastic, thermosetting polymer, or a combination thereof. The polymeric composition may include a filled or unfilled moldable plastic, polyolefins, acrylonitrile butadiene styrene (SAN), hydrogenated styrene butadiene rubbers, polyester amides, polysulfone, acetal, acrylic, polyvinyl chloride, nylon, polyethylene terephthalate, polycarbonate, thermoplastic and thermoset polyurethanes, polyethylene, polystyrene, synthetic and natural rubbers, epoxies, polystyrene, thermoplastic elastomer (TPO, TPE, TPR), polyamides, silicones, vinyl based resins, or any combination thereof. The polymeric composition may be free of fillers, fibers, reinforcing materials, or a combination thereof. The polymeric composition may include fillers such as colorants, fire retardant (FR) or ignition resistant (IR) materials, reinforcing materials, such as glass or mineral fibers, surface modifiers, or a combination thereof. The polymeric composition may also include anti-oxidants, release agents, blowing agents, and other common plastic additives. Examples of suitable polymeric compositions are found in U.S. Patent Application Publication No. 2011/0100438 the contents of which are expressly incorporated by reference herein for the polymeric compositions.

The photovoltaic components may be created by any process where the resulting structure is substantially flat and free of warp, curl, or both. The photovoltaic components may be created by compression molding, injection molding, lamination, thermoforming, rotational molding, or a combination thereof. Preferably, the photovoltaic components are produced by injection molding. During processing of the base plate the material properties of the resultant photovoltaic components may be substantially different as a result of the flow directions of the polymeric composition (i.e., longitudinal and normal (transverse) directions). These materials may result in a different elastic modulus between the length and width versus a material without the anisotropic materials, and therefore the angle of reinforcement ribs may be varied so that the elastic moduli of the length and width are substantially equal. The teachings herein may include additional teachings that may be found in U.S. Provisional Patent Application No. 61/829,680 filed on May 31, 2013, which is incorporated by reference here in its entirety and specifically paragraph nos. 0032 to 0066 and FIGS. 1-11 as to the ribs, the process of making the ribs, the composition of the ribs, and the support portion. Preferably, one of the photovoltaic components as discussed herein is a photovoltaic module and the photovoltaic module includes a base plate and a photovoltaic laminate.

The one or more base plates may function to support a photovoltaic laminate. The one or more base plates may function to protect a roofing structure from fluids. Each base plate may include a support portion, an active portion, and an overlap portion. The active portion may overlap all or a portion of one or more adjacent photovoltaic components, one or more flashing components, or both (e.g., the overlap portion) forming a “double overlap” so that each photovoltaic module may be protected and connected to a connection surface and/or so that the combined photovoltaic components may form a shingle structure for diverting fluids from the roof of the structure. Each of the photovoltaic modules may have a portion that may be indirectly and/or directly connected to a connection surface. The base plate may directly connect to a connection surface and the photovoltaic laminate may be connected to a support portion of the base plate (i.e., the photovoltaic laminate may be indirectly connected to the connection surface). Preferably, the overlap portion of each of the photovoltaic modules may be directly connected to a connection surface, and the active portion may be connected directly to the overlap portion or directly to the connection surface by a fastener that extends through the overlap portion, around the overlap portion, through a fastener support in the overlap portion, or a combination thereof. More preferably, each of the photovoltaic modules may include a base plate and a photovoltaic laminate and the base plate is connected to a connection surface by one or more fasteners that extend through fastener supports and preferably a plurality of fasteners that extend through fastener supports.

The base plate may be connected to the support structure and function to provide roofing functions. The base plate may function to connect a photovoltaic laminate (hereinafter pv laminate) to a connection surface (e.g., a roof). The base plate may function to allow for decoupled expansion and contraction of the pv laminate relative to the base plate or vice versa. The base plate may function to allow for removal, replacement, repair, or a combination thereof of the pv laminate without removal of the entire pv module from the connection surface. The base plate may function to protect all or a portion of the pv laminate. The base plate may connect the pv laminate to a connection surface. The base plate may protect one or more connectors and or wiring. The base plate may retain roofing functions, fire retardant properties, or both when the pv laminate is removed from the base plate. The base plate may include one or more features to assist in forming a connection with one or more connection devices. The base plate may include one or more devices that receive a portion of a fastener, assist in forming a connection, or both. The base plate may include an active portion and an overlap portion.

The active portion may function to generate electricity when a pv laminate is connected to the base portion. The active portion may be a portion of the pv laminate that is not covered by one or more adjacent photovoltaic modules. The active portion may be a combination of a support portion of the base plate and a pv laminate.

The support portion may function to provide support to one or more pv laminates. The support portion may support one or more pv laminates during transportation. The support portion may function to support the pv laminate when a load is applied to the pv laminate while the pv laminate is connected to a connection surface. For example, when the photovoltaic module is connected to a roof and a person walks across the photovoltaic array the support portion may resist bending of the pv laminate so that the pv laminate is not damaged. The support portion may function to provide support for one or more adjacent photovoltaic modules. The support portion of a first photovoltaic module may function to overlap one or more connectors of one or more second adjacent photovoltaic modules so that the one or more connectors of the one or more second adjacent photovoltaic modules are protected. The support portion of a first photovoltaic module may protect one or more connectors that are connected to and extend between two adjacent second photovoltaic modules. The support portion may provide longitudinal support, lateral support, or both so that the pv laminate does not substantially deflect (i.e., enough to crack, break, or be damaged). The support portion and the pv laminate may be connected. Preferably the support portion and the pv laminate may be movable relative to each other when the pv laminate is connected to the support portion. For example, the support portion may have a coefficient of thermal expansion that is greater than that of the pv laminate and the support portion may expand relative to the pv laminate while providing support to the pv laminate. The support portion may not provide any sealing functions to the pv laminate. The pv laminate and the support portion may be free of a sealed connection. The support portion may resist deflection and provide support to the pv laminate during loading. The support portion may function to remove fluids and/or debris away from the pv laminate. The support portion may include one or more support ribs spaced apart from one or more fluid transfer surfaces. The support portion may be part of an active component.

An active component may be any component that includes an active portion that assists in generating power. The active component may convert sunlight to electricity. The active component may function to generate power. One preferable active component is a photovoltaic module as discussed herein. Preferably, the active component is any component that includes a pv laminate.

The one or more and preferably the plurality of pv laminates may be configured in any manner so that each of the plurality of active components (e.g., photovoltaic modules) may be electrically connected. The pv laminates may include a protective cover (e.g., a glass cover or a barrier plastic cover) and at least one pv cell (e.g., an electrical circuit). Each of the individual photovoltaic modules (i.e., the pv laminates in the photovoltaic modules) may be electrically connected to an adjacent photovoltaic module by one or more connectors. The one or more connectors may comprise a ribbon, a positive buss bar, a negative buss bar, a wire, a part of an integrated flashing piece, or a combination thereof. The connector may extend between two adjacent photovoltaic modules and forms an electrical connection. The connectors may assist in securing the two or more adjacent photovoltaic modules to a support structure. Preferably, the connectors do not assist in connecting the photovoltaic modules to a support structure and the photovoltaic modules are connected to the roof structure by a fastener. Preferably, the overlap support portion is free of connectors. The connectors may be a separate piece, a discrete piece, or both that connects two or more adjacent photovoltaic modules, integrated flashing pieces, or a combination of both. The connectors may extend from an active portion of the photovoltaic module, be part of a photovoltaic module, or both. The connectors may be an integral part of a pv laminate.

The one or more flashing components may function to create a fluid impenetrable barrier. The one or more flashing components may function to cover one or more active components and prevent fluid from entering the photovoltaic array. The one or more flashing components may end one or more rows. The one or more flashing components may connect two or more rows. The one or more flashing components may have a portion that extends under an active component, under a standard roofing shingle, over an active component, over a standard roofing shingle, or a combination thereof. The one or more flashing components may form a cap over one or more photovoltaic components. The one or more flashing components may include an overlap portion, a cap portion, or both. The one or more flashing components may form a terminal end of one or more rows. The one or more flashing components may connect two or more rows together. The one or more flashing components may end one row and begin an adjacent row (e.g., a row located above or below). The one or more flashing components may be free of any active portion, any portion that produces power, or both. The one or more flashing components may protect the active components. The one or more flashing components may connect one or more rows of active components together. The one or more flashing components may cover one or more through holes, handles, connection recesses, or a combination thereof in the active components, in other flashing components, or both. The one or more flashing components may create a tortuous path for water to enter the photovoltaic array in a direction opposite the slope of the roof. The one or more flashing components may seal the peripheral edge of the photovoltaic array. The edge of one or more of the flashing components may include one or more side ledges.

The flashing components may include one or more side ledges. Some of the flashing components may include one or more side ledges. Some of the flashing components may be free of side ledges. Flashing components may include a plurality of side ledges. The side ledges may extend the length of one or more of the edges of the flashing components. Preferably, the side ledges extend less than the length of one or more edges of the flashing components. The side ledges may connect to an adjacent side ledge to form a fluid barrier. The side ledges may mate with the standard shingles. The side ledges may taper between the top of the photovoltaic array and the standard shingles. A portion of the side ledges may extend under the standard shingles. A portion of the side ledges may extend over and into contact with the standard shingles (e.g., asphalt shingles, stucco shingles, clay shingles). The side ledges may be in communication with each other and form a peripheral edge around the photovoltaic array. The side ledges may prevent water from creeping under the flashing components, the active components, or both. The side ledges may overhang the photovoltaic array, a standard shingle, or both. The one or more side ledges may extend from cap portions of a flashing component. The side ledges may be proximate to or opposite one or more flashing interfaces. Preferably, when a flashing component includes a side ledge, the component does not include a flashing interface.

The one or more flashing interfaces may function to interface with standard shingles, roofing material, or both. The one or more flashing interfaces may prevent fluid from extending from the roof onto the photovoltaic array. The one or more flashing interfaces may guide water along a side of the photovoltaic array without the water entering onto the photovoltaic array. The flashing interface may overlap a standard shingle, a roofing material, or both. The flashing interface may be overlapped, overlap, or both a standard shingle, a roofing material, or both. The flashing interface may receive an adjacent photovoltaic component, an adjacent flashing component, a photovoltaic module, or a combination thereof. The flashing interface may extend over standard roofing shingles at some locations and under standard roofing shingles in other locations. The flashing interface may interface within a row, with a row below, or both. The flashing interface may prevent water from entering the photovoltaic array. The flashing interface may be located under a side ledge, adjacent a side ledge, under a side ledge of a different photovoltaic component, or a combination thereof. The flashing interface may be flat, taper away from the photovoltaic array, angle away from the photovoltaic array, be located on a peripheral edge, or a combination thereof. A corner flashing piece may include two flashing interfaces. A center flashing piece may include one flashing interface. A row-to-row flashing piece may include one or more or even two or more flashing interfaces. The one or more flashing interfaces may include one or more ramps.

The one or more ramps may function to create a transition on the one or more photovoltaic components. The one or more ramps may move a flashing interface from extending over a standard shingle to under a standard shingle or vice versa. The one or more ramps may be a transition along one or more edges. The one or more ramps may assist in creating a fluid barrier. The one or more ramps may partially cover one or more roofing components and be partially covered by one or more roofing components. The one or more ramps may partially cover a standard roofing shingle and/or partially be covered by a standard roofing shingle. The one or more ramps may increase the size (e.g., thickness or height) of the flashing walls so that the flashing walls prevent fluid from entering the photovoltaic array. The flashing interfaces may terminate at one or more flashing walls.

The one or more flashing walls may function to prevent fluid from entering into the photovoltaic array. The one or more flashing walls may function to create a barrier that is taller than a standard roofing shingle, a roofing material, or both. The one or more flashing walls may prevent wind from blowing water under one or more photovoltaic components, blowing water from a standard roofing shingle unto the photovoltaic array, or both. The one or more flashing walls may be sufficiently tall that fluid cannot move from the standard roofing portion to the photovoltaic array. The one or more flashing walls may form an interface with the standard roofing shingles so that water cannot penetrate into the photovoltaic array. One or more edges of the photovoltaic array may include two or more flashing walls. One or more edges of the photovoltaic array may include a single flashing wall. The flashing interface may extend over standard roofing shingles at some locations and under standard roofing shingle in other locations. The flashing walls may terminate the flashing interfaces. The flashing walls may terminate at a flashing extension.

The one or more flashing extensions may function to form an overlapped connection with an adjacent flashing component. The one or more flashing extensions may function to create a water tight connection between two adjacent flashing components. The one or more flashing extensions may function as a locating feature, a partial locating feature, or both. The one or more flashing extensions may align with a flashing extension of another photovoltaic component. The one or more flashing extensions may interlock with a flashing extension of another flashing component. One flashing extension may align with a pocket of an adjacent photovoltaic extension. The flashing extensions prevent rain from being driven up the photovoltaic array and under the one or more photovoltaic components. The one or more flashing extensions may extend under a flashing extension of an adjacent flashing component, under a main portion of a flashing component, or both. The one or more flashing extensions may extend over a flashing extension of an adjacent flashing component, under a main portion of a flashing component, or both. The one or more flashing extensions may extend the flashing interface beyond a main edge of the flashing component. The one or more flashing extensions may be rectangular, square, triangular, semi-circular, a rhombus, symmetrical, asymmetrical, or a combination thereof. The one or more flashing extensions may interlock, overlap, abut, or a combination thereof with another flashing extension. The one or more flashing extensions may be located on starter row components only (i.e., the first row of photovoltaic components that are placed on a roof structure). The one or more flashing extensions may be located on edge components, cap components, or both. Preferably, the flashing extensions of the flashing components are free of flashing extensions. A flashing component may include one or more or two or more flashing extensions. When more than one flashing extension is present it is preferred that one is a male flashing extension and one is a female flashing extension. Some flashing extensions may be male flashing extensions and other flashing extensions may be female flashing extensions. The male flashing extensions may extend over an adjacent flashing extension or flashing component and align with a pocket. The female flashing extensions may include a pocket that receives and forms a connection with a male flashing extension.

The one or more pockets may function to create a water tight connection with an adjacent flashing extension. The one or more pockets may receive an adjacent flashing extension. The one or more pockets may include one or more flashing walls. The one or more pockets may be formed in the flashing interface, above the flashing interface, partially in the flashing interface, and partially adjacent to the flashing interface, or a combination thereof. The one or more pockets may be a recess that receives a flashing extension so that the flashing extension is flush with the other photovoltaic components. The one or more pockets may include one or more steps that mirror steps on the flashing extensions. The one or more pockets may be located on starter row components only (i.e., the first row of photovoltaic components that are placed on a roof structure). The one or more pockets may be located on edge components, cap components, or both. Preferably, the cap portions of the flashing components are free of pockets.

The one or more cap portions may function to cover one or more through holes, recesses, or both. The one or more cap portions may function to prevent fluid from penetrating into the photovoltaic array. The one or more cap portions may be a final row of a photovoltaic array. The one or more cap portions may complete a final row, be a top layer of a row, a top layer of the photovoltaic array, or a combination thereof. The one or more cap portions may overlap one or more photovoltaic components. The one or more cap portions may be free of through holes, handles, connection recesses, fastener locations, alternative fastener locations, or a combination thereof. The one or more cap portions may be substantially solid. The photovoltaic components that include a cap portion may only include a cap portion. The photovoltaic components may include a cap portion and another portion (e.g., an overlap portion). The one or more cap portions may include one or more connection hooks for forming a connection with an adjacent photovoltaic component. The one or more cap portions may include one or more alignment slots, alignment ribs, or both for alignment with the one or more adjacent photovoltaic components. The one or more cap portions may be the only portion of a flashing component. The one or more cap portions may include one or more cap extensions that extend over a portion of a second row, an adjacent row, or both.

The one or more cap extensions may function to extend a cap portion from a first row to a second row. The one or more cap extensions may extend from a top row to a row below the top row. The one or more cap extensions may create a fluid barrier that covers a seam between two rows. The one or more cap extensions may form a connection with a row-to-row flashing piece, a row-to-row connection portion, or a combination thereof. The one or more cap extensions may create a generally “L” shaped section. The one or more cap extensions may be located below a plane of a cap portion. The one or more cap extensions may be located in the same plane as the cap portion. The one or more cap extensions may be located at an edge of a photovoltaic array. The one or more cap extensions may complete a row-to-row connection. The one or more cap extensions may include any of the features of the cap portion and may perform any of the functions of the cap portions. The one or more cap extensions may be smaller than the one or more cap portions. The one or more cap portions, one or more cap extensions, or both may be free of an alignment rib, an alignment slot, or both.

The one or more alignment ribs may function to align one or more photovoltaic components relative to each other. The one or more alignment ribs may prevent one photovoltaic component from moving relative to another photovoltaic component. The one or more alignment ribs may extend under and/or over an adjacent photovoltaic component. Preferably, the one or more alignment ribs extend from an upper surface of a photovoltaic component. More preferably, the one or more alignment ribs extend from an upper surface of a row-to-row connector portion. The alignment ribs may be located only on row-to-row flashing pieces. The alignment ribs may be located on corner flashing pieces, center flashing pieces, or both. The corner flashing pieces, the center flashing pieces, or both may be free of alignment ribs. The one or more alignment ribs may be a linear piece that extends vertically above a top surface of a flashing component. The one or more alignment ribs may be linear, serpentine, include one or more bends, include one or more curves, or a combination thereof. The one or more alignment ribs may provide a feature that forms a complementary fit with one or more alignment slots of an adjacent photovoltaic component.

The one or more alignment slots may function to receive an alignment rib to align two photovoltaic components relative to each other. The one or more alignment slots may form a complementary fit with one or more alignment ribs. The one or more alignment slots may prevent movement of a photovoltaic component that includes an alignment rib when the alignment slot and alignment rib are in communication. The one or more alignment slots may be a region formed between ribs, through ribs, by an absence of ribs, or a combination thereof. The one or more alignment slots may be located entirely on a bottom side of a photovoltaic component and preferably a flashing component. A portion of the alignment slot may form a raised portion on a top side of a photovoltaic component and preferably a flashing component. The one or more alignment ribs may extend along a length, a width, diagonally, in a straight line, a curved line linearly, include one or more bends, include one or more curves, or a combination thereof. Preferably, whatever the shape of the alignment slots are the alignment ribs are the same shape and vice versa. Preferably, the alignment slots and the alignment ribs have complementary shapes. The alignment slots may be located on a bottom side so that when a photovoltaic component extends over another photovoltaic component the alignment rib extends into the alignment slot. The one or more alignment slots may be located in one or more cap portions, one or more flashing components that include a cap portion, or both. The one or more alignment slots may be located in a flashing piece when the flashing piece is a standard piece, a plus piece, a minus piece, or a combination thereof.

The one or more standard pieces may function to assist in collecting sunlight and creating power. The one or more standard pieces may be a standard size. The one or more standard pieces may be sized so that one piece may form a partial overlap of at least two pieces. The standard piece may have a length (X) and a width (Y). Length when discussed herein is the distance along the slope and width is the direction transverse to the length. The standard pieces may have a width that is less than the plus pieces and is greater than the minus pieces.

The plus pieces may function to fill a space created by one or more pieces being offset. The plus pieces may function to fill a space that is wider than a standard space (i.e., the space between two photovoltaic components when fully installed). The photovoltaic array may include one or more plus pieces. The photovoltaic array may include a plurality of plus pieces. One or more rows may include one or more plus pieces. The length of the plus piece may be the same as a standard piece and a minus piece (i.e., X). The photovoltaic components may have a standard length, a minus length, a plus length, or a combination thereof. The length of a plus length piece may be about 1.2X or more, about 1.5X or more, or even about 1.8X or more. The length of the plus piece may be about 4X or less, about 3X or less, or about 2X or less. The plus length piece may function to extend fully or partially between two or more rows. The plus length piece may fully cover a minus length piece and fully or partially cover a standard length piece. The plus length piece may electrically connect two adjacent rows. The length of a minus length piece may be about 0.8X or less, about 0.7X or less, or about 0.5X or less. The length of a minus length piece may be about 0.3X or more, about 0.4X or more, or even about 0.45X or more. The minus length piece may function to only receive a portion of a length of a standard piece, or a plus length piece so that the standard piece, the plus length piece, or both covers all of the minus length piece and a portion of a piece in an adjacent row. The minus length piece may be a base piece. The plus pieces may have a greater length due to the addition of a row-to-row connector portion, a cap extension, a flashing extension, or a combination thereof. The length and width of the photovoltaic components may include the flashing interfaces, the flashing extensions, or both. Preferably, the length and the width of the photovoltaic components is the body portion. More preferably, the length and width of the photovoltaic components is measured without measuring the flashing interface, the flashing extension, or both.

The width of the plus piece may be greater than a standard piece. The width of a plus piece may be about 1.1Y or more, about 1.2Y or more, about 1.3Y or more, or even about 1.5Y or more. The width of a plus piece may be about 2Y or less, about 1.8Y or less, or even about 1.7Y or less than a standard piece. The width of a plus piece relative to a minus piece may be about 1.5Y or more, about 1.7 or more, or even about 1.8Y or more. The width of a plus piece relative to a minus piece may be about 2.5Y or less, about 2.3Y or less, or about 2Y or less. The plus piece may have a portion that extends between two adjacent rows. Preferably, the plus piece includes a portion that extends between two adjacent photovoltaic modules. The plus piece may include one or more cap portions. The plus piece may be a corner flashing piece. The plus piece may be a row-to-row flashing piece. The plus piece may be a center flashing piece. Preferably, the plus pieces are corner flashing pieces. The plus pieces may assist in creating a step-out, a step-in, or both. The plus pieces may be located in the same row as a minus piece so that the offset of the pieces is compensated for and a square, rectangular, symmetrical, or a combination thereof photovoltaic array is created. The plus pieces may assist in forming an irregular photovoltaic array so that the photovoltaic array accommodates one or more roofing components. A row may include an equal number of plus pieces as minus pieces.

The one or more minus pieces may function to fill in a gap created by one or more pieces being offset within a row. The one or more minus pieces may fill in a gap created by one or more plus pieces being installed. The one or more minus pieces may fill in a gap created by a row-to-row connector. The photovoltaic array, a row, or both may include one or more minus pieces. The photovoltaic array, a row, or both may include a plurality of minus pieces. The minus pieces may extend within a single row. The minus pieces may extend within multiple rows. The minus pieces may be a cap portion, a flashing component, a corner flashing piece, a center flashing piece, a row-to-row flashing piece, or a combination thereof. The one or more minus pieces relative to a standard piece may have a width that is about 0.5Y or more, about 0.6Y or more, about 0.7Y or more, or even about 0.75Y or more. The one or more minus pieces relative to a standard piece may have a width that is about Y, about 0.9Y or less, or about 0.8Y or less. The one or more minus pieces may assist in maintaining all of the rows the same length. The one or more minus pieces may assist in forming a photovoltaic array that is square, rectangular, symmetrical, or a combination thereof. The one or more minus pieces may assist in terminating a row, extending a row, or both. The one or more minus pieces may assist in creating a step in, a step-out, or both. The one or more minus pieces may preferably be a row-to-row flashing piece, a corner flashing piece, or a combination of both.

The one or more corner flashing pieces may function to terminate one or more rows. The one or more corner flashing pieces may be located in a corner of the photovoltaic array. The one or more corner flashing pieces may include at least two flashing interfaces. The flashing interfaces on a corner flashing piece may be at an angle relative to each other. The angle of the flashing interfaces on a corner flashing piece may be about 60 degrees or more, about 75 degrees or more, or even about 85 degrees or more from each other (i.e., about 90 degrees). The angle of the flashing interfaces on a corner flashing piece may be about 135 degrees or less, about 115 degrees or less, or even about 105 degrees or less from each other. The one or more corner flashing pieces may interface with standard roofing shingles on two or more edges. The one or more corner flashing pieces may include one or more flashing extensions. The one or more corner flashing pieces may have a portion that extends under one or more adjacent flashing pieces, one or more center flashing pieces, one or more row-to-row flashing pieces, one or more standard shingles, or a combination thereof. The one or more corner flashing pieces may be a portion of a starter row, a portion of an ending row, or both. The one or more corner flashing pieces may not be located within internal rows. The one or more corner flashing pieces may be part of an internal row when the photovoltaic array includes a step in, a step-out, or both. The one or more corner flashing pieces may be terminal pieces. The one or more corner flashing pieces may be a top right, top left, bottom right, bottom left, minus piece, plus piece, standard piece, or a combination thereof.

The top right minus piece, top right plus piece, or both may function to form a portion of an ending row. The top right minus piece, top right plus piece, or both may function to cap a portion of a row. The top right minus piece, top right plus piece, or both may entirely be a cap portion or a cap portion and a cap extension. The top right minus piece, top right plus piece, or both may include one or more side ledges. The side ledges may be on one or more edges of the top right minus piece, top right plus piece, or both. The top right minus piece, top right plus piece, or both may include one or more alignment slots. The top right minus piece may have a width that is less than a standard piece (e.g., the top right minus piece may have any of the dimensions discussed herein as to a minus piece). The top right plus piece may have a width that is greater than a standard piece (e.g., the top right plus piece may have any of the dimensions discussed herein as to a plus piece). The top right minus piece, top right plus piece, or both may extend over a portion of a photovoltaic module, a portion of a row-to-row connector, or both. The top right minus piece, top right plus piece, or both may be free of through holes. The top right minus piece, top right plus piece, or both may include one or more and preferably a plurality of connection hooks. The top right minus piece, top right plus piece, or both may extend over a row-to-row connection portion, over an alignment rib, or both. The top right minus piece, top right plus piece, or both may be free of a flashing extension. The top right minus piece, top right plus piece, or both may extend in only one row. The top right minus piece, top right plus piece, or both may extend in two or more rows. The top right minus piece may be used instead of a top right plus piece or vice versa. The top right minus piece, the top right plus piece, or both may be located on opposite edges of the photovoltaic array as a top left minus piece, a top left plus piece, or both. Preferably, when a top right plus piece is used on one edge a top left minus piece is used on the opposing edge. Correspondingly, when a top right minus piece is used on one edge a top left plus piece is used on the opposing edge.

The top left minus piece, top left plus piece, or both may function to form a portion of an ending row. The top left minus piece, top left plus piece, or both may function to cap a portion of a row. The top left minus piece, top left plus piece, or both may be a cap or a cap and cap extension. The top left minus piece, top left plus piece, or both may include one or more side ledges. The side ledges may be on one or more edges of the top left minus piece, top left plus piece, or both. The top left minus piece, top left plus piece, or both may include one or more alignment slots. The top left minus piece may have a width that is less than a standard piece (e.g., the top left minus piece may have any of the dimensions discussed herein as to a minus piece). The top left plus piece may have a width that is greater than a standard piece (e.g., the top left plus piece may have any of the dimensions discussed herein as to a plus piece). The top left minus piece, top left plus piece, or both may extend over a portion of a photovoltaic module, a portion of a row-to-row connector, or both. The top left minus piece, top left plus piece, or both may be free of through holes. The top left minus piece, top left plus piece, or both may include one or more and preferably a plurality of connection hooks. The top left minus piece, top left plus piece, or both may extend over a row-to-row connection portion, over an alignment rib, or both. The top left minus piece, top left plus piece, or both may be free of a flashing extension. The top left minus piece, top left plus piece, or both may extend in only one row. The top left minus piece, top left plus piece, or both may extend in two or more rows. The top left minus piece may be used instead of a top left plus piece or vice versa. The top left minus piece, top left plus piece, or both may be located on opposite edges of the photovoltaic array as a top right minus piece, a top right plus piece, or both.

The bottom left plus piece, bottom left minus piece, bottom right plus piece, bottom right minus piece, or a combination thereof may function to terminate one or more rows. The bottom left plus piece, bottom left minus piece, bottom right plus piece, bottom right minus piece, or a combination thereof form a terminal piece. The bottom left plus piece, bottom left minus piece, bottom right plus piece, bottom right minus piece, or a combination thereof may be a base piece that begins a row, begins the photovoltaic array, or both. The bottom left plus piece, bottom left minus piece, bottom right plus piece, bottom right minus piece, or a combination thereof may be entirely directly connected to a support structure and the pieces in an adjacent row may overlap a portion and build off of the bottom left plus piece, bottom left minus piece, bottom right plus piece, bottom right minus piece, or a combination thereof. The bottom left plus piece, bottom left minus piece, bottom right plus piece, bottom right minus piece, or a combination thereof may be part of a starter row, may form opposing edges of a starter row, or both. The bottom left plus piece, bottom left minus piece, bottom right plus piece, bottom right minus piece, or a combination thereof may include one or more side ledges. Preferably, the bottom left plus piece, bottom left minus piece, bottom right plus piece, bottom right minus piece, or a combination thereof each include at least two side ledges that are on opposing edges. The bottom left plus piece, bottom left minus piece, bottom right plus piece, bottom right minus piece, or a combination thereof may include only connection recesses, be free of connection hooks, or both. The bottom left plus piece, bottom left minus piece, bottom right plus piece, bottom right minus piece, or a combination thereof may include one or more flashing interfaces. The one or more flashing interfaces each extend along one or more walls. Preferably, the bottom left plus piece, bottom left minus piece, bottom right plus piece, bottom right minus piece, or a combination thereof each include a flashing interface along two edges. The bottom left plus piece, bottom left minus piece, bottom right plus piece, bottom right minus piece, or a combination thereof may include one or more flashing walls and preferably at least one edge includes two or more flashing walls. The bottom left plus piece, bottom left minus piece, bottom right plus piece, bottom right minus piece, or a combination thereof may include one or more flashing extensions. When a bottom left plus piece is installed a bottom right minus piece may be installed. Conversely, when a bottom right plus piece is installed a bottom left minus piece may be installed. The bottom right pieces (plus or minus) may be located on opposite edges as the bottom left pieces (plus or minus). The bottom left plus piece, bottom left minus piece, bottom right plus piece, bottom right minus piece, or a combination thereof may be used in a row other than the starter row. The bottom left plus piece, bottom left minus piece, bottom right plus piece, bottom right minus piece, or a combination thereof may be part of a step in, a step-out, or both. The bottom left plus piece, bottom left minus piece, bottom right plus piece, bottom right minus piece, or a combination thereof may be in communication with a center flashing piece, also the top right plus piece, top right minus piece, top left plus piece, top left minus piece, or a combination thereof may be in communication with one or more center flashing pieces.

The one or more center flashing pieces may function to extend between edges of a photovoltaic array. The one or more center flashing pieces may provide support for one or more active components. The one or more center flashing pieces may cap one or more active components. The one or more center flashing pieces may be part of a starter row, an ending row, or both. The one or more center flashing pieces may connect to another center flashing pieces, a corner flashing piece, or both. The one or more center flashing pieces may include one or more flashing interfaces. The one or more center flashing pieces may include one or more flashing extensions. The one or more center flashing pieces may include a flashing extension on a first side, a second side, or both sides. The one or more center flashing pieces may include one or more flashing walls. Preferably, the center flashing pieces include at least two flashing walls. The one or more center flashing pieces include a peripheral edge and the connection members may be located inside of the peripheral edge. The one or more center flashing pieces may include only connection hooks or only connection recesses. The one or more center flashing pieces may include one or more pockets. Preferably one flashing extension includes a pocket and one flashing extension is free of a pocket. The one or more center flashing pieces may be a bottom piece, a top piece, or both.

The one or more top pieces may function to cap the photovoltaic array. The one or more top pieces may function to cover one or more connection recesses, one or more handles, one or more through holes, or a combination thereof of one or more photovoltaic components. The one or more top pieces may include only connection hooks. The one or more top pieces may include one or more openings. The one or more top pieces may receive one or more doors. The one or more top pieces may extend between the edges of the photovoltaic array without extending to an edge of the photovoltaic array. The one or more top pieces may be free of contact with a row-to-row flashing piece. The one or more top pieces may be located opposite the one or more bottom pieces.

The one or more bottom pieces may function to connect to a support structure. The one or more bottom pieces may function to extend between two corner pieces. The one or more bottom pieces may include a row of connection members. Preferably, the one or more bottom pieces may include a row of connection recesses (e.g., a plurality of connection recesses). The one or more bottom pieces may form an interface with standard shingles. The one or more bottom pieces may form the base for the entire photovoltaic array. The one or more bottom pieces may form a base connection structure. The one or more bottom pieces may be the first pieces of the photovoltaic array that are installed. The one or more bottom pieces may form one or more starter rows. The one or more bottom pieces may form a complete starter row and may form a partial starter row. The one or more bottom pieces may create multiple starter rows or starter row portions in an irregular photovoltaic array. The bottom pieces form one or more steps along one or both edges of a photovoltaic array. For example, the bottom pieces may create more than one starter row so that the photovoltaic array widens in one direction. A photovoltaic array that includes two or more starter rows or portions of starter rows may be an irregular photovoltaic array, include a step-out, or both. The bottom pieces in a step-out may connect to a row-to-row flashing piece. The bottom pieces in a step-out may have a reduced width. The bottom pieces in a step-out may extend away from a center of the photovoltaic array so that the step-out is farther from the center than the adjacent row, a row under the step-out, or both (i.e., a row up the slope of the roof extends farther from the center than a row that it overlaps). The bottom pieces in a step-out may be a plus piece that is reduced to a standard width. The bottom pieces may include one or more cut lines (or a cut indicator), removable portions, or both.

The one or more cut lines may function to indicate a removable portion. The one or more cut lines may indicate a portion that may be removed to create a step-out. The one or more cut lines may indicate a part that may be removed by cutting, breaking, folding, or a combination thereof. The one or more cut lines may function as an alignment feature. The one or more cut lines may assist in creating a straight cut. The one or more cut lines may determine the width, length, size, or a combination thereof of a step-out. The one or more cut lines may reduce a piece in width, length, or both. The one or more cut lines may run along a width, a length, or both. The one or more cut lines may reduce the width or length of a photovoltaic component from a plus size to a standard size, from a plus size to a minus size, from a standard size to a minus size, or a combination thereof. The one or more cut lines may be a surface marking. The one or more cut lines may be a recess, scoring, or both. The one or more cut lines may be a through hole. The one or more cut lines may be a weakened area that may be removed without the use of tools. Preferably, the one or more cut lines assist a user in cutting the photovoltaic component to a desired length, width, or both. The one or more cut lines may assist a user in forming a straight edge. The one or more cut lines may form an edge that mates with a row-to-row connector. The one or more cut lines may function to indicate a location of modification for a photovoltaic component so that a step-out is formed.

When there is a desire or need to space a substantially rectangular array, it may be necessary to shift some rows in an array to left or to right to create a space to left or right and above or below (e.g. up roof or down roof) of certain rows in the array. The one or more spaces are a lack of photovoltaic components to accommodate standard roofing elements (e.g. asphalt shingles) or a roofing component (e.g., a chimney, irregular roof shape or other obstacle discussed herein), while maximizing the area used by the photovoltaic array. The one or more spaces may be created by a step-in or a step-out as discussed above. The one or more spaces are generally bordered on two or more edges by photovoltaic components. For example, a space formed by a step-in or step-out may have an edge that borders a vertical part of a photovoltaic component and a horizontal photovoltaic component. The one or more spaces may be an open corner area. space

The step-out may shift a photovoltaic array in a transverse direction to the left or the right such that subsequently applied rows extend further than earlier applied rows and/or up roof rows extend further than the down roof rows. A step-outstep-out may have two row-to-row flashing pieces that are vertically offset so that the row-to-row connectors are not aligned. The step-out may move, widen, shift, or a combination thereof a photovoltaic array or a portion of a photovoltaic array. The step-out may move a photovoltaic array or a portion of a photovoltaic array from a center of the photovoltaic array, a midpoint of the photovoltaic array, or both. Preferably, the step-out shifts a row and all of the rows that build off of that row from a midpoint or a center of the photovoltaic array. The step-out may shift one or more rows as the rows extend up the photovoltaic array towards an apex of a roof. Stated another way as the photovoltaic array is built towards an apex of a roof a step-out may cause one of the rows (and the rows above that row) to shift away from the center of the photovoltaic array. Preferably, a step-out has two adjacent row-to-row flashing pieces offset by at least a width or length of a minus piece, a standard piece, a plus piece, or a combination thereof. The one or more step-outs may be located in internal rows of the photovoltaic array. The step-outs may be all on one edge. The step-outs may be on opposing edges. Multiple step-outs may be on each edge. The step-out may function to create a partial starter row (i.e., a row that does not have any photovoltaic components located below (i.e., towards a bottom edge of a roof)). For example, the step-out may extend over, above, or both that is formed so that one or more flashing pieces form a partial starter row above the space. The step-out may be all or a portion of a first row and the first row may overlap a second row, a third row, or both and the second row, third row, or both may be located down the roof from the first row. The step-out may form one or more spaces that are bordered on two or more sides by the step-out.

The one or more row-to-row flashing pieces may extend between two or more rows. The one or more row-to-row flashing pieces may function to physically connect, electrically connect, or both, two or more adjacent rows. The row-to-row flashing pieces may electrically connect a first row to a second row. The row-to-row flashing pieces may extend between two or more rows or three or more rows. The row-to-row flashing pieces may electrically connect two rows and cap a portion of one row while providing a support structure for a portion of another row. The row-to-row flashing pieces may include a cap portion, an overlap portion, or both. The row-to-row flashing pieces may be a corner piece as well as a row-to-row flashing piece. The row-to-row flashing pieces may include one or more flashing interfaces, one or more flashing walls, one or more flashing extensions, or a combination thereof. The row-to-row flashing pieces may include a plurality of connection members. The row-to-row flashing pieces may include connection hooks, connection recesses, or both. The row-to-row flashing pieces may include a row-to-row connection portion. The row-to-row connection portion may extend between a first row and a second row. A row-to-row connector portion may separate two portions of a row-to-row flashing piece. For example, the row-to-row connector portion may separate a cap portion and an overlap portion, separate two cap portions, separate two overlap portions, or a combination thereof. The row-to-row flashing pieces may include one or more connector channels and preferably two connector channels. One connector channel may be located in a row-to-row connection portion and the other connector channel may be located in an overlap portion, a cap portion, or both. The row-to-row flashing pieces may include a plurality of ribs. The ribs may include one or more and preferably a plurality of snap slots that extend between and connect two connector channels, a connector channel and a through roof connection, or both. The row-to-row flashing pieces may include one or more alignment ribs, one or more alignment slots, or both. The row-to-row flashing pieces may be located on a right side, a left side, or both. The right side pieces may be a reverse mirror image to the left side pieces. The row-to-row flashing pieces may be step-in left, a step-in right, a left piece, left plus piece, left minus piece, a right piece, a right plus piece, a right minus piece, or a combination thereof.

The step-in right pieces, step-in left pieces, or both (i.e., step-in pieces) like the pieces used to form a step-out function to create a non-square or non-rectangular photovoltaic array (i.e., an irregular photovoltaic array). The step-in right pieces, step-in left pieces, or both function to shift to accommodate a roofing structure or a roof obstacle. The step-in right pieces, step-in left pieces, or both may terminate one row and extend a row. The step-in right pieces, step-in left pieces, or both may shift a row to one side. The step-in right pieces, step-in left pieces, or both may have a portion that extends over one row and may have an overlap portion that extends under another row. The step-in right pieces, step-in left pieces, or both may include connection hooks and connection recesses. The step-in right pieces, step-in left pieces, or both may extend, shorten, shift, or a combination thereof a right side or a left side respectively of a photovoltaic array. For example, the step-in right piece may create a step on the right side of the photovoltaic array so that a second edge, a space, or both are created on the right side of the photovoltaic array. The step-in right pieces, step-in left pieces, or both preferably include at least two connector channels for receiving a connector from one or more rows. The step-in right pieces, step-in left pieces, or both may connect two or more internal rows. The step-in right pieces, step-in left pieces, or both may be located opposite or be used in lieu of a left piece, a right piece, or both. The step-in right pieces, step-in left pieces, or both may include a row-to-row connector portion that extends between two halves.

The row-to-row connector portion of a step-in piece may function to separate two functional halves of the step in. The row-to-row connector portion of a step-in feature may include an extending row portion which also serves as a cap portion, an overlap portion, or both from another cap portion, an overlap portion, or both. The row-to-row connector portion may function to electrically continue a row when a row is shortened for a step in. The row-to-row connector portion of a step-in may separate the two functional halves. The row-to-row connector portion of a step-in may connect two or more adjacent rows electrically, physically, or both. The row-to-row connector portion may separate an overlap portion from a cap portion; two cap portions; two overlap portions; or a combination thereof.

The one or more overlap portions of a step-in feature may function similar to the overlap portions discussed herein for row-to-row flashing pieces. The one or more overlap portions may terminate a row, partially terminate a row, or both. Preferably, the one or more overlap portions may function to accept an adjacent photovoltaic component so that the photovoltaic component is retained within the photovoltaic array. The one or more overlap portions may be a partial overlap. For example, one side of the step-in feature may have a portion that is an overlap portion and a portion that is a cap portion. The partial overlap portion may be overlapped by another photovoltaic component and may form a cap that partially overlaps a portion of another photovoltaic component. The partial overlap portion may receive a photovoltaic component so that a double overlap is created. The partial overlap portion may be a standard size or a minus size so that an offset is created from the step in. The partial overlap portion may be a top half or a bottom half of one or both sides of the step-in piece. Preferably, one side of the step-in includes at least a partial overlap portion. More preferably, one side of the step-in is a partial overlap portion and a partial cap portion and the other half is a full cap portion. The partial overlap portion may assist in capping a portion of a row while continuing a row so that a step is formed.

The one or more cap portions of the step-in may function similar to the cap portions discussed herein. The one or more cap portions may be located on one or both sides of the row-to-row connector portion. The one or more cap portions may be a full cap portion or a partial cap portion. The full cap portions may at least partially terminate a row and cap an adjacent piece. The full cap portions may create a double overlap with a row that is down the slope so that the full cap portion extends over the lower photovoltaic component. The full cap portions may generally be part of an ending row or a partial ending row. The full cap portions may be located on an opposite side of a row-to-row connector portion from another full cap portion, a full overlap portion, a partial cap portion and a partial overlap portion, or a combination thereof. The partial cap portion may partially terminate a row and provide support for a photovoltaic component in a row that is continuing (i.e., a row that is stepped in). The partial cap portion may provide a double overlap for one row so that water is prevented from penetrating into that row, while the partial overlap portion assists in continuing or starting another row. The cap portion may be partially covered by one or more standard shingles. The partial cap portions may not be connected to or in contact with the standard shingles. The partial cap portion may be located internally due to the overlap portion. The partial cap portion, the partial overlap portion, the full cap portion, the full overlap portion, or a combination thereof create a dual function for the step-in piece so that one row is terminated while one row is started or continued.

The dual functions of the step-in piece function to space a roof obstacle while maximizing the area of the photovoltaic array. The dual functions permit one or more rows to be terminated while one or more rows are continued. The dual functions create one or more spaces as discussed herein. The dual functions assist in creating the double overlap. The dual functions may create a watertight irregular photovoltaic array. The dual functions may create a step-in on the left, on the right, or both depending on the position of the cap portions, the overlap portions, or both.

The one or more step-ins may function to create a space, a step, or both up roof from a portion of the rows of a photovoltaic array (i.e., towards the ending rows or on the top of the slope of a roof or towards an apex of a roof). The one or more step-ins may extend a row inward towards a center of a photovoltaic array, towards a middle of the photovoltaic array, or both. Virtually any of the rows of the photovoltaic array may include a step-in and the rows that overlap the stepped in row may maintain the step-in or include another step in or later rows may be stepped out. The one or more step-ins may form a space on a side of the photovoltaic array facing an apex of the roof. The one or more step-ins may step towards a center of a row. The one or more step-ins may cap a portion of the photovoltaic array while another portion of the photovoltaic array continues. The photovoltaic array may include one or more step-ins on each side. The photovoltaic array may include multiple step-ins on each side of the photovoltaic array. The one or more step-ins may be used with a step-out, without a step-outstep-out, with other step-ins, be a single step-in, or a combination thereof. The one or more step-ins may be a row-to-row flashing piece and may be used with a right piece, a left piece, or both or in lieu of a left piece, a right piece, or both.

The one or more left pieces, one or more right pieces, or both may function to connect two or more internal rows. The one or more left pieces, one or more right pieces, or both may be located on edges of the photovoltaic array. The left pieces, the right pieces, or both may be plus pieces (width, length, or both), minus pieces (width, length, or both), or a combination of both. For example, the one or more left pieces, one or more right pieces, or both may connect a second row to a third row or a third row to fourth row. The one or more left pieces, one or more right pieces, or both may connect an internal row to an ending row. The one or more left pieces, one or more right pieces, or both may have a row-to-row connector portion that extends along the peripheral edge of the photovoltaic array. The one or more left pieces, one or more right pieces, or both may have a cap portion that extends over a photovoltaic component, an overlap portion that extends under a photovoltaic component, or a combination of both. A right piece and a left piece may not be located directly opposite each other. For example, a right piece connects row two and row three and the left piece connects row three and row four. The right piece and the left piece may be staggered from row-to-row so that the electrical circuitry extends in a serpentine manner. The one or more left pieces, one or more right pieces, or both may include one or more connector hooks, one or more connector recesses, or both. The one or more left pieces, one or more right pieces, or both may include one or more flashing interfaces, one or more flashing extensions, or both. The one or more left pieces, one or more right pieces, step-in right, step-in left, or a combination thereof may include one or more alignment ribs, one or more alignment slots or both. Preferably, the alignment ribs are located on the row-to-row connector portion.

The row-to-row connector portion preferably functions to electrically connect, physically connect, or both, two adjacent rows usually on alternate ends of rows. For example, a row-to-row connector on the left side of the array may be used to connect rows one and two while a row-to-row connector on the right side of the same array will be used to connect rows two and three and another row-to-row connector will then be used on the left side to connect rows three and four. The row-to-row connector portion may have two connector channels that connect two rows. The row-to-row connector portion may include one connector channel and the connector channel may be electrically connected to an adjacent connector channel so that power is transferred between two adjacent rows. The row-to-row connector portion may include one or more flashing interfaces, flashing walls, flashing extensions, or a combination thereof. The row-to-row connector portion may be free of any connection members. Preferably, the row-to-row connector portion includes a connection member. More preferably, the row-to-row connector portion includes one or more connection recesses. The row-to-row connector portion may include one or more connection hooks, one or more connection recesses, or both. The row-to-row connector portion may include one or more fastening locations. The row-to-row connector portion may include one or more alignment ribs, one or more alignment slots, or both. The row-to-row connector portion may include one or more ribs, one or more snap slots, or both. The row-to-row connector portion may connect to one or more bottom pieces.

The bottom left minus piece, a bottom left plus piece, a bottom right minus piece, a bottom right plus piece, or a combination thereof may function to connect a bottom row to an adjacent row. The bottom left minus piece, a bottom left plus piece, a bottom right minus piece, a bottom right plus piece, or a combination thereof may extend over a corner flashing piece, a bottom flashing piece, or both. The bottom left minus piece, a bottom left plus piece, a bottom right minus piece, a bottom right plus piece, or a combination thereof may include a row-to-row connector portion that extends from the first row to a second row. For example, the row-to-row connector portion may extend from the starter row to the next adjacent row. The bottom left minus piece, a bottom left plus piece, a bottom right minus piece, a bottom right plus piece, or a combination thereof may form both a base part of the starter row and extend to an adjacent row. The bottom left minus piece, a bottom left plus piece, a bottom right minus piece, a bottom right plus piece, or a combination thereof may have the row-to-row connector portion on the right side (if a right piece) or the left side (if a left piece). The bottom left minus piece, a bottom left plus piece, a bottom right minus piece, a bottom right plus piece, or a combination thereof may form a connection with a standard shingle, an overlap with a shingle, or both. The minus pieces and the plus pieces include one or more of the features taught herein and incorporated by reference into the teachings of the bottom left minus piece, a bottom left plus piece, a bottom right minus piece, a bottom right plus piece, or a combination thereof. If a row has a bottom right piece (plus or minus) the row does not include a bottom left piece (plus or minus) or vice versa. For example, if a photovoltaic array includes a bottom right minus piece that connects the first row and the second row, then the left side does not have a bottom left minus piece and has a left piece that connects the second row to the third row. The bottom left minus piece, a bottom left plus piece, a bottom right minus piece, a bottom right plus piece, or a combination thereof preferably, have a cap portion, an overlap portion, or both on one side of a row-to-row connector portion. The bottom left minus piece, a bottom left plus piece, a bottom right minus piece, a bottom right plus piece, or a combination thereof may be free of a cap portion, an overlap portion, or both on both sides of the row-to-row connector portion.

The one or more openings may function to provide access to the photovoltaic components when the photovoltaic components are connected together. The one or more openings may function to create access to one or more conductors, one or more connector channels, or both. The one or more openings may assist in connecting two or more photovoltaic components. The one or more openings may allow for a connector of a pv laminate to be removed and/or added to the photovoltaic array without moving or removing any photovoltaic components. The opening may function to allow an integrated frame, connector, or both to be removed from a concealed location, inserted into a concealed location, or both. The opening may allow for one or more tools to access an integrated frame, a connector, or both. The one or more openings may include one or more sockets so that a door may close the opening.

The one or more sockets may function to connect a door to the photovoltaic module. The one or more sockets may allow for rotational movement of the door between an open and closed position. The one or more sockets may lock a door in place. The one or more sockets may receive a portion of the door, a projection of the door, or both so that a connection is formed. The one or more sockets may be formed in one or more ribs. The one or more sockets may be located on an underside of the photovoltaic components. The one or more sockets may allow a door to be added and removed while the photovoltaic component is connected within the photovoltaic array.

The one or more doors may cover an opening. The one or more doors may function to prevent fluid from penetrating into an opening. The one or more doors may function to prevent fluid from moving in the opposite direction as the slope of the roof and penetrating the photovoltaic array. The one or more doors may seal an opening. The one or more doors may include a seal. The one or more doors may be free of a seal. The one or more doors may be locked in place when the photovoltaic array is complete. The one or more doors may be added after the photovoltaic array is created. The one or more doors may extend into the opening. The one or more doors may include one or more projections that connect the door within the photovoltaic device.

The one or more projections may function to connect a door within a socket, an opening, or both. The one or more projections may function to form a connection with a socket. The one or more projections may extend into a socket. The one or more projections may allow for a door to be removed from an opening, a photovoltaic component, or both.

The one or more alignment features function to align two or more photovoltaic components so that the two or more photovoltaic components may be connected. Preferably, the one or more alignment features function to align two or more connection members. More preferably, the one or more alignment features function to align one or more connection hooks with one or more connection recesses. Most preferably, the one or more alignment features function to align a plurality of connection hooks with a plurality of connection recesses during blind installation and assist in locking the plurality of connection hooks within the plurality of connection recesses. The alignment features may indicate a locked position, an unlocked position, or both. The alignment features may function to connect two or more photovoltaic components of varying shape, size, dimensions, or a combination thereof. The one or more alignment features may be a marking on the surface of the photovoltaic components. The one or more alignment features may be a structure that is integral to the photovoltaic component. The alignment features may be a visual indicator. The one or more alignment features may be used to align one photovoltaic component, two photovoltaic components, or both. The one or more alignment features may be a horizontal alignment feature, a vertical alignment feature, or both. The horizontal alignment feature and the vertical alignment features may be part of a single alignment feature, discrete from each other, located proximate to each other, or a combination thereof.

The one or more horizontal alignment features may function to horizontally align one or more photovoltaic components relative to one or more other photovoltaic components. The one or more horizontal alignment features may horizontally align connection members in a blind installation. For example, an alignment of one photovoltaic component (or its alignment features) relative to alignment features of a second photovoltaic component may result in the connection members being aligned so that visible recognition of the connection members is not needed for alignment. The one or more horizontal alignment features may horizontally align two or more photovoltaic devices relative to each other so that the connection members align during a blind installation. The horizontal alignment features may assist in creating a proper overlap, proper offset, or both between photovoltaic components. The horizontal alignment features may be a vertical line, a vertical marking, or both. The horizontal alignment feature may indicate where a side edge is located relative to the photovoltaic component. The horizontal alignment feature may be located in a central region of the photovoltaic component. The horizontal alignment feature may bisect a photovoltaic component along its height so that two equally sized pieces are formed on each side of the horizontal alignment feature. The horizontal alignment feature may be located on a bottom piece, a bottom right plus piece, a bottom left plus piece, a photovoltaic module, or a combination thereof. The horizontal alignment feature may contact one or more vertical alignment features, may be located proximate to one or more vertical alignment features, or both.

The one or more vertical alignment features may function to vertically align two or more connection members. The one or more vertical alignment features may function to vertically align two connection members relative to each other during a blind connection. The one or more vertical alignment features may function to indicate an unlocked position, a locked position, or both. The one or more vertical alignment features of a first photovoltaic component may align with vertical alignment features of a second photovoltaic component. The one or more vertical alignment features of a first photovoltaic component may be moved between two vertical alignment features of a second photovoltaic component and as the vertical alignment feature is moved between the first vertical alignment feature and the second vertical alignment feature or vice versa the connection members may be located together or unlocked. The vertical alignment feature may be aligned with one or more common features of an adjacent photovoltaic component. The vertical alignment feature may be located in a central region, an edge region, along a side, along an edge, extend from a top surface to an edge, or a combination thereof. Preferably, the vertical alignment features are located on a top surface in either a central region or one or both edge regions. The vertical alignment features may be horizontal features (e.g., extend in the transverse direction relative to the slope of the roof. The vertical alignment features may be located on a top right plus piece, a top right minus piece, a bottom piece, a bottom right plus piece, a bottom left plus piece, a left piece, a top piece, a top left minus piece, a top left plus piece, a step-in right piece, a step-in left piece, a right piece, a photovoltaic module, or a combination thereof. The one or more alignment features may include a cut indicator.

The one or more alignment features may function to align two or more photovoltaic components so that the two or more photovoltaic components may be connected. Preferably, the one or more alignment features function to align two or more connection members. More preferably, the one or more alignment features function to align one or more connection hooks with one or more connection recesses. Most preferably, the one or more alignment features function to align a plurality of connection hooks with a plurality of connection recesses during blind installation and assist in locking the plurality of connection hooks within the plurality of connection recesses. The alignment features may indicate a locked position, an unlocked position, or both. The alignment feature may function to horizontally (e.g., in a transverse direction to the slope of the support structure) align two or more photovoltaic components relative to one photovoltaic component. The alignment feature may function to vertically align two or more photovoltaic components. The one or more alignment features may be a horizontal alignment feature, a vertical alignment feature, or both. The horizontal alignment feature and the vertical alignment features may be part of a single alignment feature, discrete from each other, located proximate to each other, or a combination thereof.

The one or more horizontal alignment features may function to horizontally align one or more photovoltaic components relative to one or more other photovoltaic components for blind installation. The horizontal alignment features may assist in creating a proper overlap, proper offset, or both between photovoltaic components. The horizontal alignment features may be a vertical line, a vertical marking, or both. The horizontal alignment feature may indicate where a side edge is located relative to the photovoltaic component. The horizontal alignment feature may be located in a central region of the photovoltaic component. The horizontal alignment feature may contact one or more vertical alignment features, may be located proximate to one or more vertical alignment features, or both.

The one or more vertical alignment features may function to vertically align two or more connection members. The one or more vertical alignment features may function to vertically align two connection members relative to each other during a blind connection. The one or more vertical alignment features may function to indicate an unlocked position, a locked position, or both. The one or more vertical alignment features of a first photovoltaic component may align with vertical alignment features of a second photovoltaic component. The one or more vertical alignment features of a first photovoltaic component may be moved between two vertical alignment features of a second photovoltaic component and as the vertical alignment feature is moved between the first vertical alignment feature and the second vertical alignment feature or vice versa the connection members may be located together or unlocked. The vertical alignment feature may be aligned with one or more common features of an adjacent photovoltaic component. The vertical alignment features may be horizontal features (e.g., extend in the transverse direction relative to the slope of the roof.

The one or more installation indicators may function to indicate, depict, or both an installation location of a photovoltaic component within a photovoltaic array. The one or more installation indicators may function to depict (e.g., verbally, symbolically, graphically, or a combination thereof) the installation location of a photovoltaic component within a photovoltaic array. The installation indicators may indicate the shape of the photovoltaic array that may be formed with a specific photovoltaic component. For example, a step-in or a step-out may be formed with specific photovoltaic components. The installation indicators may provide one or more of the indications discussed herein using words, depictions, characters, symbols, letters, highlighting, or a combination thereof.

The one or more characters may function to depict verbally and explain a location of a photovoltaic component, the shape of a photovoltaic array, a modification to a photovoltaic array, or a combination thereof. The one or more characters may describe a step in, a step-out, the location of a step-out, the location of a step in, the length of the step, the width of the step, or a combination thereof. The one or more characters may identify a piece that accommodates a specific roofing structure such as a chimney, exhaust vent, window, or a combination thereof. The one or more characters may be a unique combination of letters, numbers, Greek letters, Roman numerals, Latin letters, Cyrillic letters, signs, arrows, or a combination thereof. The one or more characters may verbally explain that each of the photovoltaic components is a top, bottom, left, right, center, middle, edge, row-to-row, or a combination thereof. Preferably, the characters are letters that abbreviate the location of a photovoltaic component within a photovoltaic array.

The one or more letters may function to be an abbreviated verbal representation of the location of a photovoltaic component within a photovoltaic array. The letters may function to describe a step-in, a step-out, or both. Preferably, the letters verbally describe with an acronym the location of the photovoltaic component within a photovoltaic array. The letters may describe, top, bottom, left, right, center, middle, edge, row-to-row, or a combination thereof. The letters may abbreviate the function or shape of the photovoltaic component. For example, “INR” means the photovoltaic component steps in on the right side. The letters may be used with symbols or may be used without symbols.

The symbols may function to depict and/or describe the width, length, shape, or a combination thereof of the photovoltaic components. The symbols may function to describe if the photovoltaic component is a standard photovoltaic component or if the component serves another purpose of function. The symbols may function to describe if the photovoltaic component extends over, under, or a combination of both another photovoltaic component. The symbols may be arbitrarily chosen and a symbol may be assigned a meaning that is unique for photovoltaic components. The symbols may include a look-up table to assign a meaning or to look up a meaning. The symbols may be a graphical symbol of the photovoltaic array, the location of the photovoltaic component within a photovoltaic array, or both. The symbols may be highlighting that shows the location of a photovoltaic component within a photovoltaic array. The symbols may be mathematical symbols, symbols from a keyboard, punctuation symbols, numbers, letters, signs, marks, or a combination thereof. Preferably, the symbols indicate a length or width compared to a standard photovoltaic component (e.g., longer or shorter). More preferably, the symbols indicate a width relative to a standard photovoltaic component (e.g., longer (i.e., + (plus)) or shorter (i.e., − (minus)). The photovoltaic components may include a “+” (plus) symbol, a “−” (minus) symbol, no symbol, or a combination thereof. The symbols may be used with letters, characters, highlighting, or a combination thereof.

The highlighting may function to graphically depict the location of a photovoltaic component within a photovoltaic array. The highlighting may graphically depict the shape of the photovoltaic array. The highlighting may function to provide a visual indicator as to the location a specific photovoltaic component fits within a photovoltaic array. The highlighting may depict the photovoltaic components that form a border. The highlighting may depict the location of a photovoltaic component within a border. The highlighting may have a shape that is the same as the desired shape of the photovoltaic array. The highlighting may have a shape that a particular photovoltaic component assists in forming. The highlighting may show the shape of the photovoltaic array and the location of a photovoltaic component within the photovoltaic array. The highlighting may have a raised portion, a flat portion, or both. The highlighting may border and include the characters, symbols, letters, or a combination thereof. The highlighting, characters, symbols, letters, or a combination thereof may assist in installation of the photovoltaic components to form a photovoltaic array.

The photovoltaic array may be formed using a method. The method may include the steps of forming all or a portion of the photovoltaic array before any standard roofing components (e.g., shingles) are applied. The method may include a step of attaching the flashing components before any standard roofing components are applied. The method may include a step of adding standard roofing components and then adding photovoltaic components over a portion of the standard roofing components. Standard roofing components may be applied before and after the photovoltaic array is created but not at the same time as the photovoltaic array. The photovoltaic array, flashing components, or both may be placed over the standard roofing components. The standard roofing components may be inserted under the photovoltaic array, the flashing components, or both.

The photovoltaic array may be formed by first creating a starter row. A starter row where desired may be attached to a support structure (e.g., a roof) by one or more fasteners. The starter row may be one or more and preferably a plurality of photovoltaic components. The starter row preferably includes center flashing pieces and corner flashing pieces. The starter row may begin and end with corner flashing pieces. The starter row is overlapped by one or more photovoltaic modules (i.e., internal rows). Additional rows of photovoltaic modules may overlap the initial row of pv modules. The starter row, the one or more internal rows, or both are attached to the support structure. The one or more internal rows are attached to other internal rows, the support structure, or both. The one or more internal rows are completely or partially overlapped by an ending row. The rows are attached to the structure and the modules are interconnected. For example, a plus piece may by selected that overhangs a first photovoltaic component and covers a portions of a second photovoltaic component. Each active component may overlap two or more flashing components, two or more active components, or a combination of both. The connection members of one photovoltaic component may be aligned with another photovoltaic component. A connection hook may be blind inserted into a connection recess. The connection members may be locked together. The photovoltaic components may be moved vertically to create the lock (i.e., in a direction of the slope). The photovoltaic components may be aligned relative to each other. After forming a final row of pv modules a cap row may be applied. Cap extensions of one photovoltaic component may be aligned relative to a cap extension of another photovoltaic component. A cap extension of one photovoltaic component may be extended over a cap extension of an adjacent photovoltaic component and into a pocket of the cap extension. Where the modules comprise a base plate with a PV laminate, the PV laminates may be installed on the base plates before installation, after installation, or a combination of both. Connecting two or more rows together by inserting a row-to-row flashing piece at the end of two or more rows. Placing the row-to-row flashing piece over a portion of a row and forming a connection. Connecting the row-to-row flashing piece to a support structure. Placing a portion of a row over a row-to-row flashing piece. Connecting the row to the row-to-row flashing piece to two or more rows of photovoltaic modules, to another flashing component, or both. Electrically connecting the rows together by connecting alternating ends of each of the rows to the row-to-row flashing piece. Electrically connecting the active components, the flashing components, or a combination thereof together so that a photovoltaic array is created. Forming an ending row. Covering one or more photovoltaic components with components of an ending row. Inserting connection hooks of the ending row into connection recesses of the last row before the ending row. Connecting the ending row to the support structure. Capping the photovoltaic array with an ending row so that the photovoltaic array is substantially water resistant (i.e., water does not extend through the photovoltaic array to the support structure). Creating a through roof connection by extending one or more wires through a support structure.

The method includes a step of forming a step in. Placing a step-in piece that partially or fully covers one or more photovoltaic modules within a row. Capping all or a portion of one or more photovoltaic modules within a row. Overlapping a portion of the step-in piece. Terminating a portion of a row by capping the photovoltaic modules. Forming a stepped in row by overlapping a portion of the row that is not capped with one or more rows of photovoltaic modules. Placing one or more cap portions, top pieces, flashing components, or a combination thereof over a portion of a row so that the row is capped. Forming a space over the capped portion by not placing photovoltaic modules or other photovoltaic components over the capped portions. Capping a portion of a first side of a step-in piece, capping a portion of a second side of a step-in piece, forming a partial or full overlap on a first side of a step-in piece, forming a partial or full overlap on a second side of a step-in piece, or a combination thereof. Placing one or more photovoltaic modules over the partial overlap or full overlap on the first side, the second side, or both sides of the step-in piece. Electrically connecting a row with a stepped in row through the step-in piece. Abutting a photovoltaic module to the step-in piece. Forming one or more step-ins on the right side, one or more step-ins on the left side, or one or more step-ins on both sides. Stepping in a distance of one or more photovoltaic components (e.g., width).

The method includes a step of forming a step-out. Cutting one or more flashing pieces on one or both sides so that a cut flashing piece is formed. Preferably, cutting one or more bottom pieces, center pieces, or both. Placing a cut end of a cut flashing piece over a portion of a row-to-row connector portion of a row-to-row connector. Preferably, placing the cut flashing piece over an outside edge of the row-to-row connector so that the cut flashing piece partially or fully extends beyond one or more rows below the cut flashing piece. Placing a row-to-row flashing piece over the cut flashing piece. Connecting alternating ends of three or more rows of overlapping flashing pieces. For example, connecting a first row and a second row at a first end and a second row and a third row at a second end. Abutting a cut flashing piece to a row-to-row flashing piece and covering all or a portion of the cut flashing piece by another row-to-row flashing piece. Forming one or more step-out on the left side, one or more step-outs on the right side, or both sides. Stepping out a distance of one or more photovoltaic components (e.g., width). Stepping out a first row of photovoltaic modules a distance beyond a second row of photovoltaic modules and a third row of photovoltaic modules.

FIG. 1 illustrates a perspective view of a photovoltaic array 2 including a plurality of photovoltaic components 3. The photovoltaic array 2 includes three rows 4 of active components 20 with flashing components 60 located around the active components 20. As illustrated, the active components 20 are photovoltaic modules 21. The photovoltaic array 2 includes a peripheral edge 6 that forms an outer edge of the photovoltaic array 2. The photovoltaic array 2 includes a starter row 17 and an ending row 19 with a plurality of internal rows 18 extending therebetween. The starter row 17 is the first row formed and then the remaining rows are built off of the starter row 17.

FIG. 2 illustrates a cross sectional view of the photovoltaic array 2 of FIG. 1. The photovoltaic array 2 has a plurality of connecting members 10 that connect the active components 20 and the flashing components 60 together, the active components 20 to other active components 20, flashing components 60 to other flashing components 60, and a combination thereof. The connecting members 10 are located inside of a peripheral edge 6 of both the photovoltaic array 2 and each of the active components 20 and the flashing components 60. The connecting members 10 include both connection hooks 12 and connection recesses 14. The connection recesses 14 include a wall 16 that extends around each of the connection recesses 14. The active component 20 as shown includes an active portion 22 and an overlap portion 24. The active component 20 also includes a base plate 26 and a photovoltaic laminate 28 that generates power. The middle active component 20 is illustrated with the photovoltaic laminate 28 removed from the base plate 26.

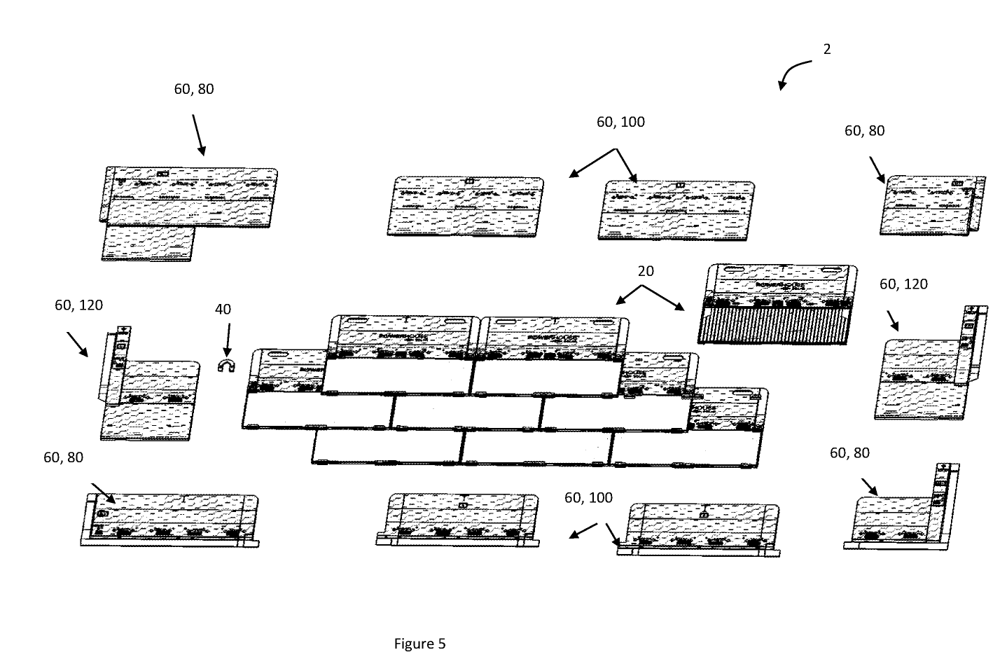

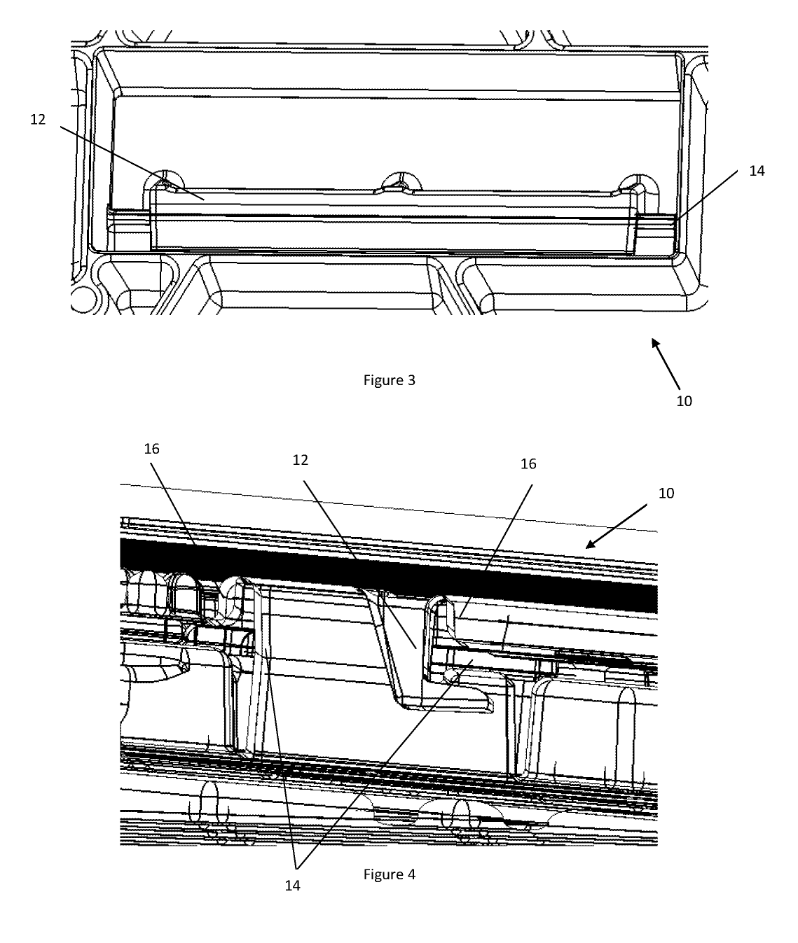

FIG. 3 illustrates a close-up view of a connection member 10 with the connection hook 12 extending through the connection recess 14 and hooking around to form a connection with the connection recess 14. The connection hook 12 contacts the connection recess 14 to prevent removal of an upper component from a lower component and to prevent wind uplift. The connection hook 12 and the connection recess 14 are both located inside of a peripheral edge of the photovoltaic components.

FIG. 4 illustrates a close-up view of the cross-sectional view of FIG. 2. As shown the connection members 10 are mated. The connection hook 12 is extended through the connection recess 14 and is in contact with the connection recess 14. A wall 16 extends around the connection recess 14 and the connection hook 12 that prevents fluids from penetrating to the next level of the photovoltaic array. The wall 16 of the connection recess 14 and the wall of the connection hook 12 form a complementary fit so that a tortuous path is created and fluid is prevented from penetrating through the connection recess 14.

FIG. 5 illustrates an exploded view of the photovoltaic array 2. The photovoltaic array includes a plurality of active components 20 (e.g., photovoltaic modules) and a plurality of flashing components 60. The flashing components include corner flashing pieces 80, center flashing pieces 100, row-to-row flashing pieces 120, and a door 140 (not shown). One connector 40 is shown that interconnects (e.g., electrically and physically) the components together.

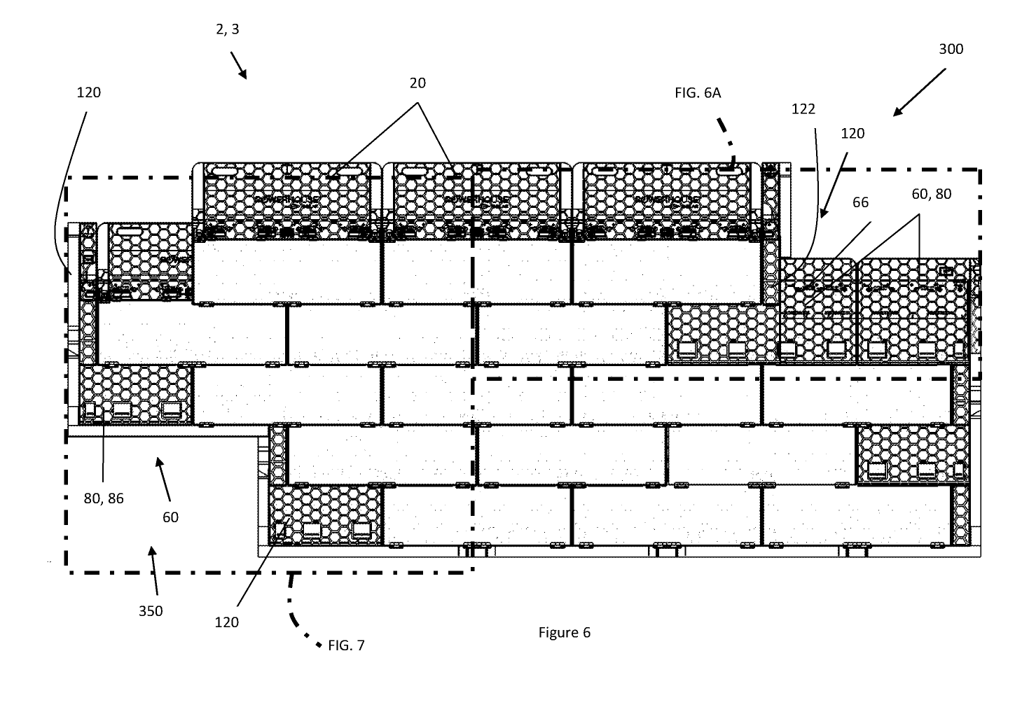

FIG. 6 illustrates a top view of a photovoltaic array 2 that is an irregular photovoltaic array 3. The irregular photovoltaic array 3 includes a plurality of active components 20 (i.e., photovoltaic modules. One side (right as shown) includes a right step-in 300 and a left step-out 350. The right side includes a pair of flashing components 60 located side by side with one flashing component 60 being a corner flashing piece 80 and one flashing component 60 being a row-to-row flashing piece 120. The row-to-row flashing piece 120 is a step-in right piece 122 that has an additional overlap portion 66 that shifts the active components 20 over by the length of the overlap portion 66 so that the photovoltaic array 2 shifts to accommodate a pre-existing structure or to follow a pre-existing structure so that a surface area used by the photovoltaic array 2 can be maximized. The left step-out 350 includes a flashing components 60 including a pair of row-to-row flashing pieces 120 that are separated by a corner flashing piece 80. The corner flashing piece 80 is a bottom left corner positive piece 86 with an end cut off. The cut off end extends over a row-to-row flashing piece 120 on the right side and the bottom left corner positive piece 86 is covered by row-to-row flashing piece 120 on the left side.

FIG. 6A illustrates a close up view of the right step-in 300. As shown, the right step-in 300 is created by a step-in right piece 122 being placed inside of a top right minus piece 82. The right step-in 300 forms a space 410 that accommodates a component of a roof or other structure. The top right minus piece 82 is smaller than the active components 20 so that the offset created is smaller than that of an active component 20. The step-in right piece 122 includes an overlap portion 66 on both sides of a row-to-row connecting portion 68. As shown only one of the overlap portions 66 is overlapped by an active component 20. If the bottom row were one or two modules longer, one or two additional flashing extended pieces (cap pieces) would be added between piece 122 and piece 82. In another embodiment the portion 72 of step-in piece 122 could be extended so that it formed the cap for the underlying photovoltaic module or part 82 could be integral to part 122.

FIG. 6B illustrates an exploded view of a portion of the right step-in 300 of FIG. 6A. The right step-in 300 forms a space 410 to accommodate a feature of a roof (not shown). A row-to-row flashing piece 120 is located in the center of FIG. 6B. The row-to-row flashing piece 120 is a step-in right piece 122 that includes a cap portion 72 that extends over a portion of an active component 20 that is a photovoltaic module 21, and an overlap portion 66 that a photovoltaic module 21 partially covers. The photovoltaic module 21 also partially covers a photovoltaic module 21 that abuts the overlap portion 66. A corner flashing piece 80 is located to the right of the row-to-row flashing piece 120 and is a top right minus piece 82 that completes a cap on an active component 20 that is a photovoltaic module 21.

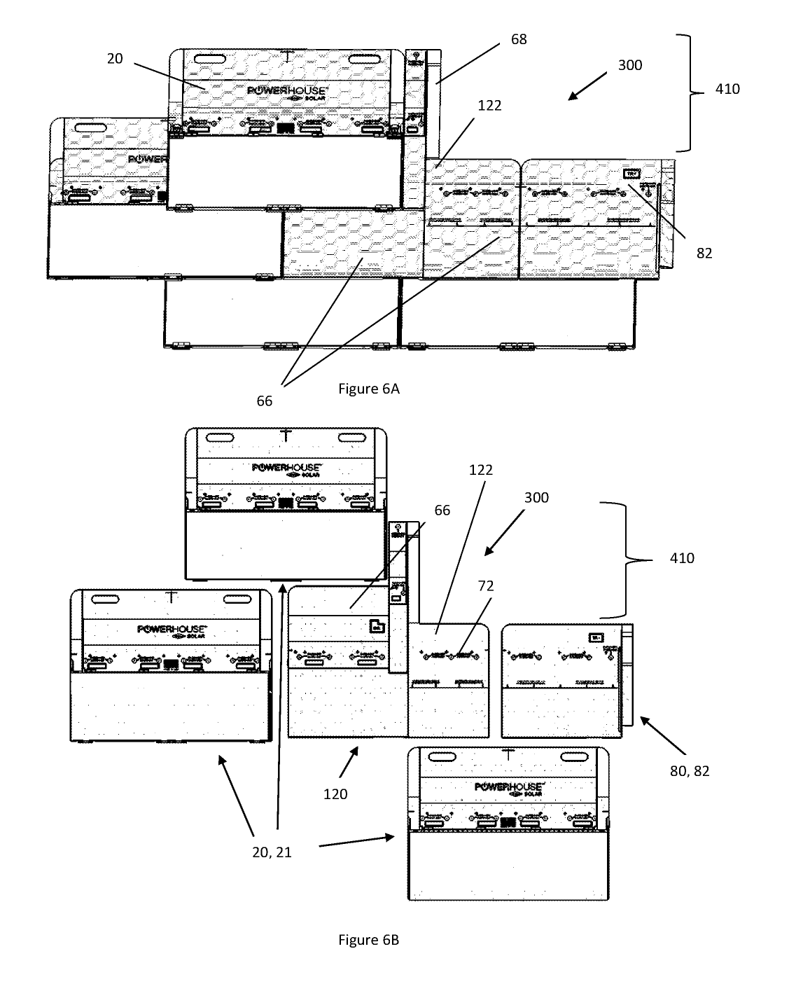

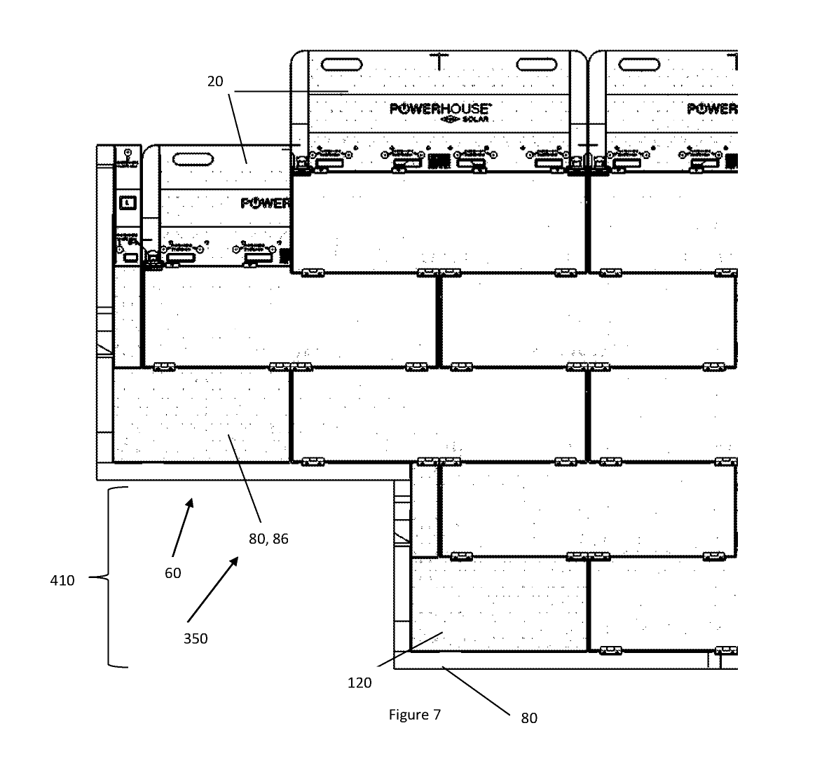

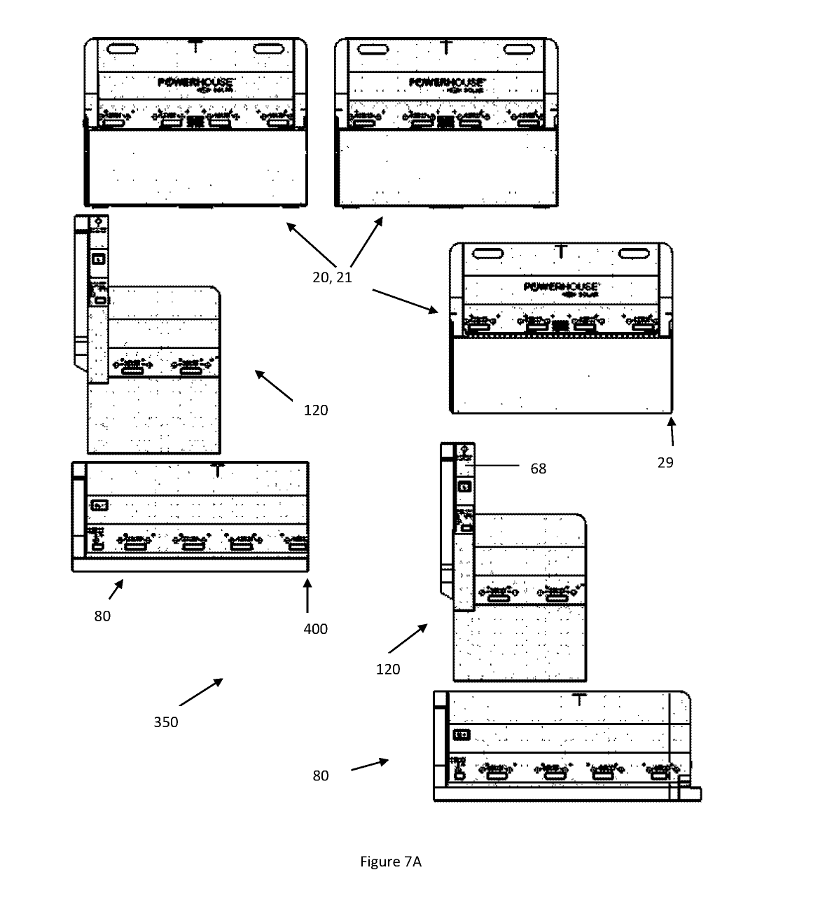

FIG. 7 illustrates a left step-outstep-out 350. The left step-out 350 shifts the active components 20 and flashing components 60 to the left forming a space 410 so that a structure of a roofing structure (not shown) may be spaced by the photovoltaic array. The left step-out 350 is created by a corner flashing piece 80 being cut so that the corner flashing piece 80 extends directly from another corner flashing piece 80. The flashing component 60 that is cut to create the left step-out 350 is a bottom left corner positive piece 86. The bottom left corner positive piece 86 is cut so that it mates with a row-to-row flashing piece 120 that overlaps a corner flashing piece 80 which forms a corner of a row below the left step-out 350.

FIG. 7A illustrates an exploded view of the components creating the left step-out 350 of FIG. 7. A row-to-row flashing piece 120 is mated with a corner flashing piece 80 to terminate a row. The row-to-row connecting portion 68 extends between a terminating row and a corner flashing piece 80 that steps the photovoltaic array one shingle to the left. The corner flashing piece 80 as shown has a piece removed along a cut line 400 so that the corner flashing piece 80 can connect to the row-to-row flashing piece 120. Active components 20 are shown as photovoltaic modules 21 that include a peripheral edge 29 and overlap a portion of the row-to-row flashing pieces 120.

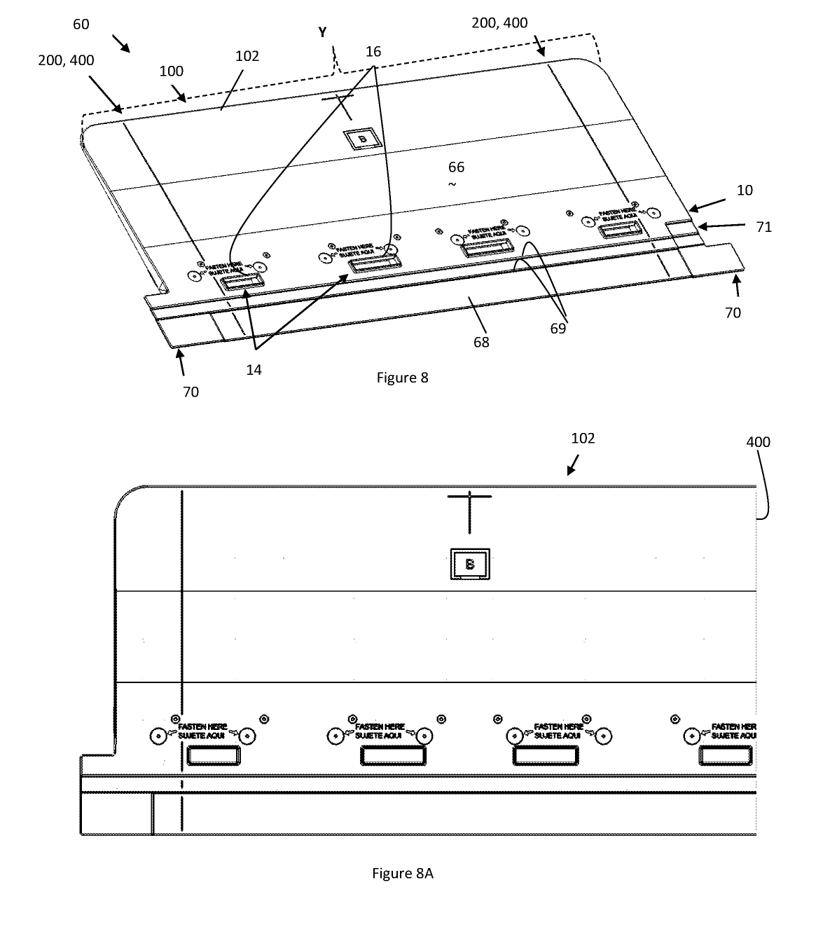

FIG. 8 illustrates a top perspective view of a flashing component 60 that is a center flashing piece 100. The center flashing piece 100 is a bottom piece 102 and has a width (Y) that is a standard width. The bottom piece 102 includes a flashing interface 68 that extends over an adjacent photovoltaic component or a shingle. The flashing interface 68 has a double flashing wall 69 that prevents fluid from going unto the photovoltaic array. Each end of the flashing interface 68 has a flashing extension 70. One of the flashing extensions 70 (e.g., a male flashing extension) is configured to extend over a flashing extension 70 with a pocket 71 (e.g., female flashing extension) and the other flashing extension 70 includes a pocket 71 that extends under and receives a flashing extension 70. Adjacent to the flashing interface 68 is a row of connection members 10. As shown the plurality of connection members 10 are connection recesses 14. Each of the individual connection recesses 14 include a wall 16 that extends around the connection recess and prevents fluid from entering the connection recess 14. A central portion of the bottom piece 102 is an overlap portion 66 that receives one or more photovoltaic components (not shown). The bottom flashing piece 102 includes cut lines 400 on each side so that the bottom flashing piece can be used to accommodate a step-out left or a step-out right. The cut lines 400 when not used for cutting can also be used as an alignment feature 200 for aligning one or more photovoltaic components relative to each other. Each side of the bottom flashing piece 102 includes a flashing extension 70 that is used to extend under or over another flashing piece or an active component.

FIG. 8A illustrates the bottom flashing piece 102 with the right side cut off along the cut line 400. The cut enables the bottom flashing piece to be used for a step-out left.

FIG. 8B illustrates the bottom flashing piece 102 with the left side cut off along the cut line 400. The cut enables the bottom flashing piece to be used for a step-out right.

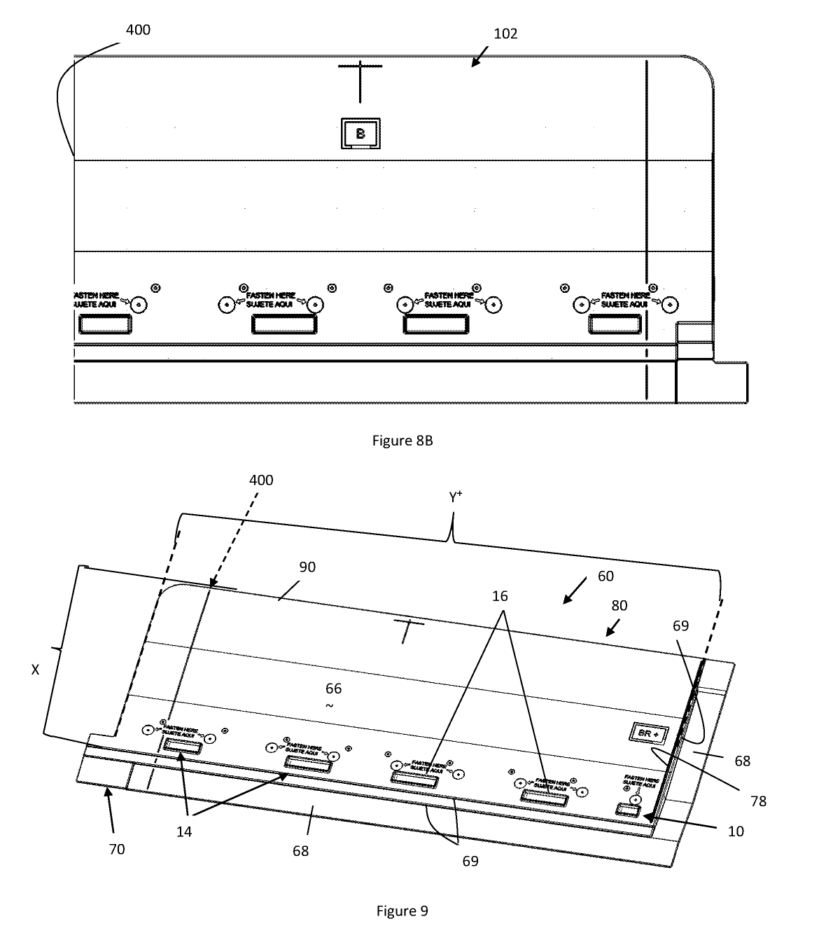

FIG. 9 illustrates a flashing component 60 that is a corner flashing piece 80 and is a bottom right plus piece 90. The bottom right plus piece 90 includes a flashing interface 68 that extends along two edges and includes a flashing wall 69 along both edges that prevent fluid from entering onto the photovoltaic array (not shown). An alignment rib 78 extends along a portion of the flashing walls 69 to further prevent fluid from entering the photovoltaic array (not shown) and for forming a connection with an adjacent photovoltaic component (not shown). The flashing interface 68 extends under shingles or one or more adjacent photovoltaic components along a vertical side edge and over shingles or one or more adjacent photovoltaic components along a bottom edge. The flashing interface 68 also includes a flashing extension 70 that extends laterally beyond the overlap portion 66. The overlap portion 66 receives a photovoltaic component and includes a row of connection members 10. The connection members 10 as shown are connection recesses 14 that include a wall 16 about each of the connection recesses 14 for preventing fluid penetration into the connection recesses 14. The bottom right plus piece 90 has a length (X) and a width (Y⁺) as shown. The corner flashing piece 80 includes a single cut line 400 and a flashing extension 70 located on a side of the cut line 400 that is removed when cut.

FIG. 9A illustrates a bottom right corner piece 90. A piece is cut off from the cut line 400 on the left side so that the bottom right corner piece 90 can be used in a step-out right. The bottom right corner piece 90 includes an alignment feature 200. The alignment feature 200 includes a horizontal alignment feature 202 and a vertical alignment feature 204 for aligning one or more photovoltaic components relative to each other.

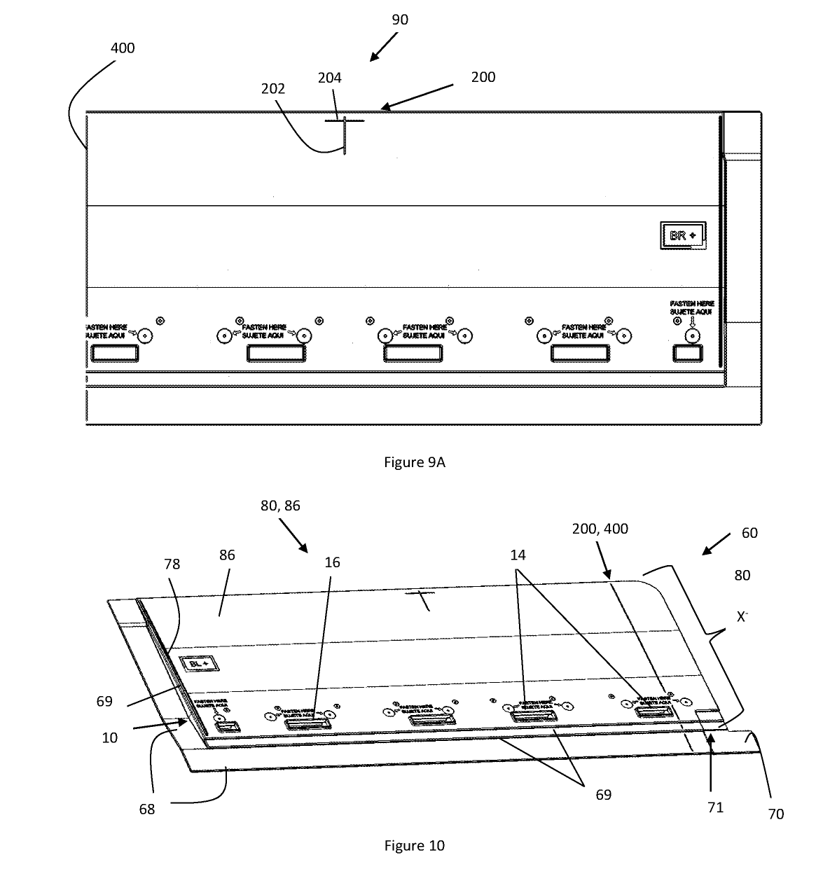

FIG. 10 illustrates a top perspective view of a flashing component 60 that is a corner flashing piece 80. The corner flashing piece 80 is a bottom left plus piece 86 and includes a row of connection members 10 that are configured as connection recesses 14 that extend through the bottom left plus piece 86, and each connection recess 14 includes a wall 16 that extends around each of the connection recesses 14. A flashing interface 68 extends along two edges of the corner flashing piece 80 so that the flashing interface 68 on a vertical edge can extend under a standard roofing material (e.g., roofing shingle) (not shown) and on a bottom edge extends over a standard roofing material. The bottom flashing interface 68 is located adjacent to two flashing walls 69 and the vertical edge flashing interface 68 is located adjacent to one flashing wall 69 to prevent fluid from moving from the roofing member (not shown) unto the bottom left plus piece 86. An alignment rib 78 extends along a portion of the flashing wall 69 so that the alignment rib 78 alignments with an alignment slot 79 (not shown) in an adjacent photovoltaic component (not shown). The flashing interface 68 includes a flashing extension 70 that includes a pocket 71 which extends under an adjacent photovoltaic component (not shown). The bottom left plus piece 86 has a length (X⁻) that is less than a standard piece such that a standard piece substantially covers the entire length of the bottom left plus piece 86 and has a portion that extends lengthwise into another row. The bottom left corner positive piece 86 includes a cut line 400 that is also an alignment feature 200. A flashing extension 70 extends from a side proximate to the cut line 400, and when a cut is made along the cut line, the flashing extension 70 is removed.

FIG. 10A illustrates the bottom left corner positive piece 86 with a cut made along the cut line 400 so that a step-out left can be formed.

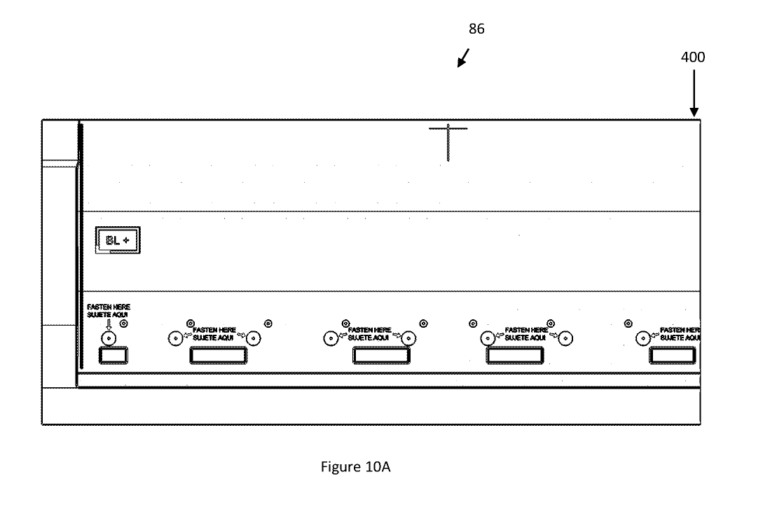

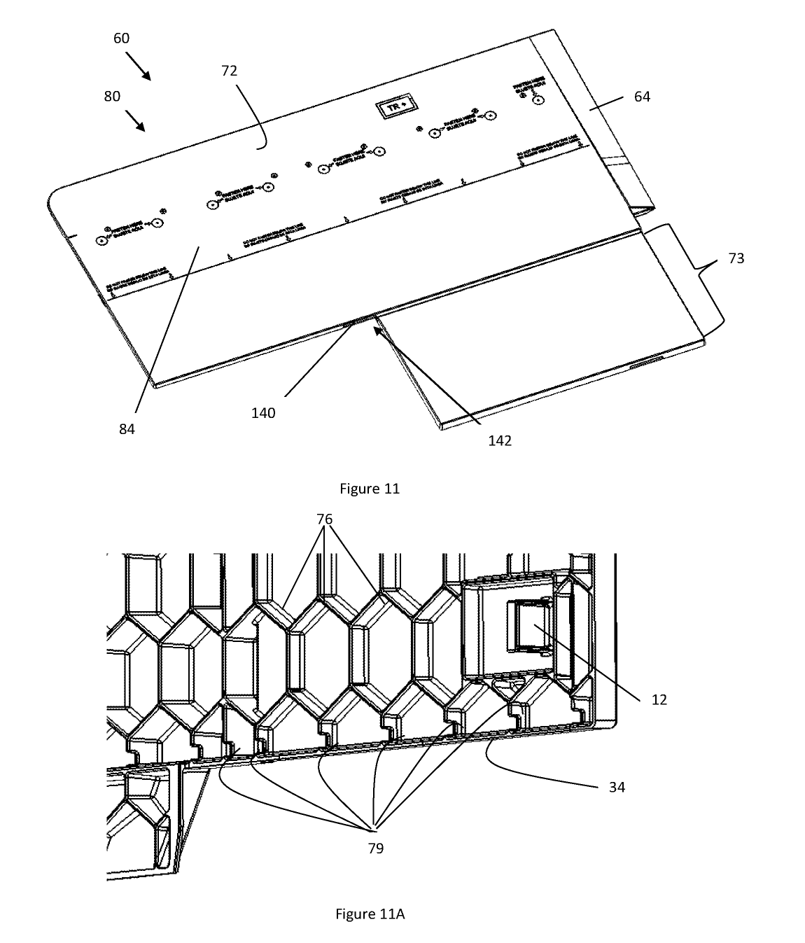

FIG. 11 illustrates a flashing component 60 that is a corner flashing piece 80. The corner flashing piece 80 is configured as a top right plus piece 84 that has a cap portion 72, which extends over an adjacent photovoltaic component (not shown) and the cap portion 72 has a side ledge 64 that moves fluid away from the photovoltaic array. The flashing component 60 includes a cap extension 73 that extends from the cap 72 over an adjacent flashing component (not shown) so that a shingle effect is created. The top right plus piece 84 includes a door 140 that covers an opening 142 so that fluid is prevented from extending under the top right plus piece 84.

FIG. 11A illustrates a close up view of the bottom of FIG. 11. An alignment slot 79 extends through the ribs 76. The alignment slot 79 extends between a side edge 34 and a connection hook 12.

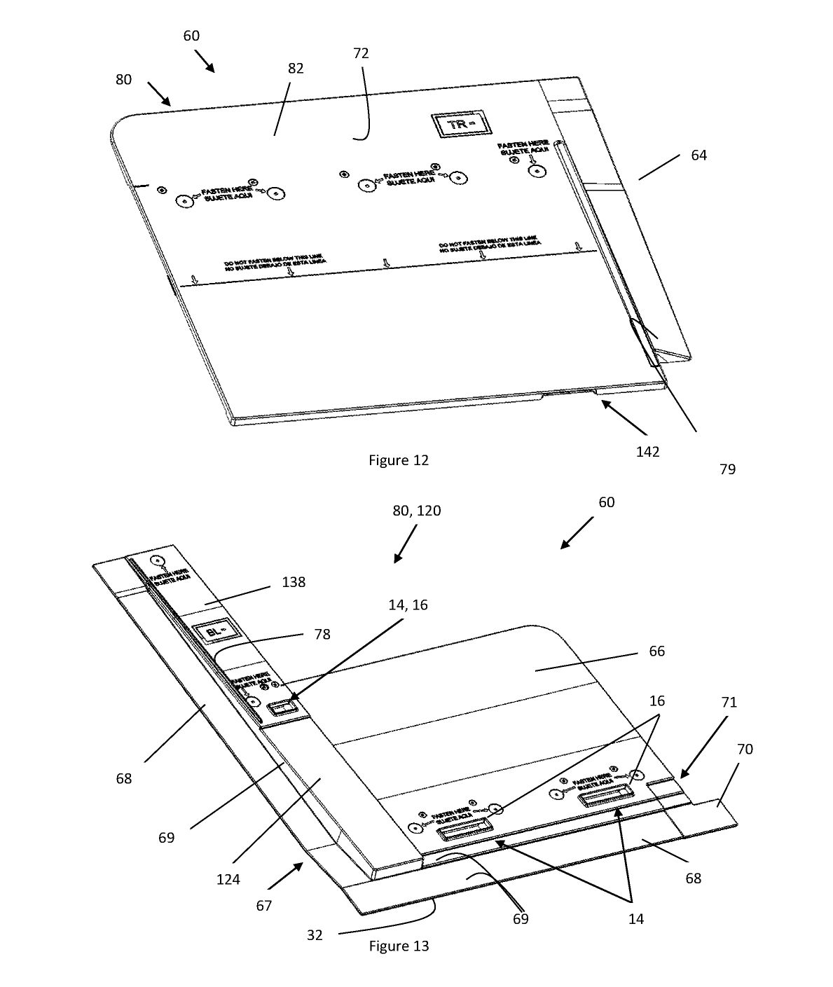

FIG. 12 illustrates a flashing component 60 that is a corner flashing piece 80. The corner flashing piece 80 is a top right minus piece 82. The top right minus piece 82 includes a cap portion 72 that extends over an adjacent photovoltaic component (not shown) and a side ledge 64 that guides fluids from the cap portion 72 off of the top right minus piece 82. An alignment slot 79 has a raised portion on a top surface of the top right minus piece 82 to assist in receiving an alignment rib (not shown). An opening 142 is shown on the bottom of the top right minus piece 82 and a door is not shown in the opening 142.

FIG. 13 illustrates a top perspective view of a flashing component 60 that serves as both a corner flashing piece 80 and as a row-to-row flashing piece 120. The flashing component 60 is a bottom left minus piece 124 and includes an overlap portion 66 and a row-to-row connector portion 138. The row-to-row connector portion 138 extends outward so that the row-to-row connector portion 138 connects the row-to-row flashing piece 120 to a photovoltaic component in its row as well as an adjacent row (shown in FIG. 1). The row-to-row connection portion 138 includes an alignment rib 78 that forms a connection with an alignment slot 79 (not shown), and a connection recess 14 including walls 16. The row-to-row connector portion 138 includes a flashing interface 68 that extends under another photovoltaic component or a roofing component to form a seal to resist penetration of fluids. The flashing interface 68 extends along two sides of the bottom left minus piece 124 so that a corner is created. The flashing interface 68 includes a ramp 67 along the side that changes the relationship of the flashing interface 68 from extending over standard shingles (not shown) along the bottom to extending under standard shingles (not shown) along the edge. A flashing wall 69 is adjacent to the flashing interface 68 and the flashing wall 69 creates a barrier and prevents fluid from extending from the flashing interface 68 onto the photovoltaic array (not shown). Two flashing walls 69 are located proximate to the bottom edge 32 so that a double tortuous path is created. The row-to-row connector portion 138 is connected to an overlap portion 66 that extends therefrom. The overlap portion 66 includes a pair of connection recesses 14 for receiving a connection hook (not shown) of an adjacent photovoltaic component. Each of the connection recesses 14 include a wall 16 that extends around the periphery of the connection recess 14 and prevents fluid from extending into the connection recess 14. A flashing extension 70 extends from the overlap portion 66 that extends under an adjacent photovoltaic component (not shown) so that water is prevented from penetrating between the bottom left minus piece 124 and the adjacent photovoltaic component. A pocket 71 is located adjacent to the flashing extension 70 and the pocket 71 receives a flashing extension 70 from an adjacent photovoltaic component to assist in preventing fluid penetration.

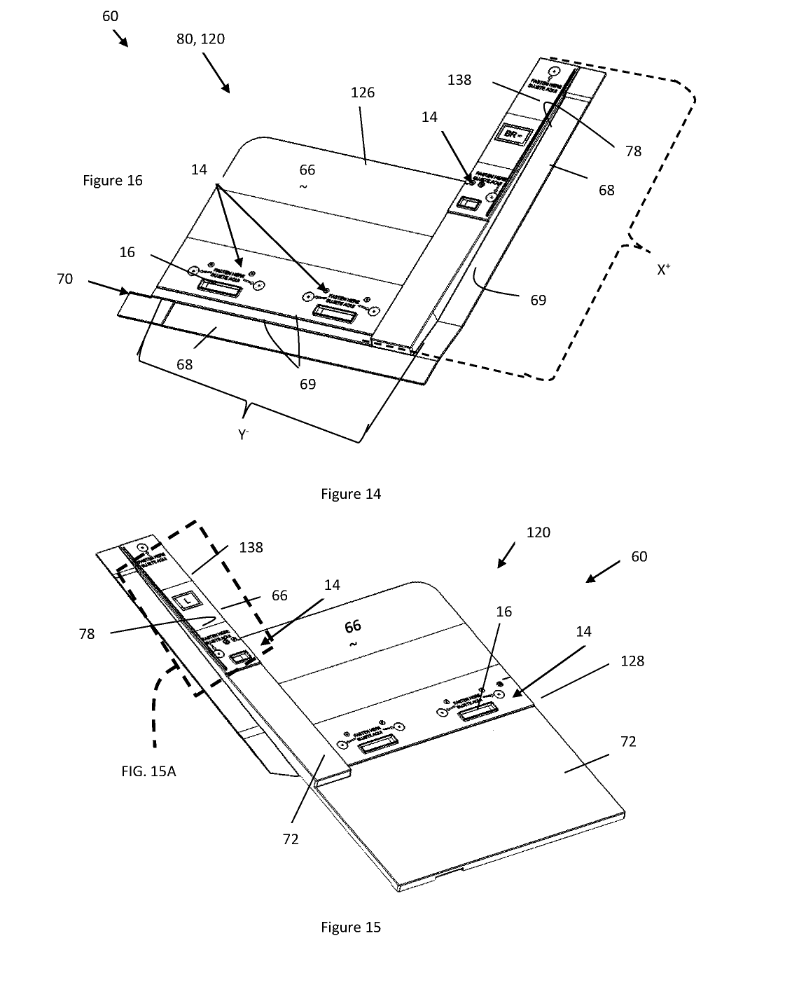

FIG. 14 illustrates a flashing component 60 that as shown is both a corner piece 80 and a row-to-row flashing piece 120. The flashing component 60 is a bottom right minus piece 126. The bottom right minus piece 126 includes a row-to-row connector portion 138 that extends between two adjacent rows and an overlap portion 66 extending from the row-to-row connector portion 138. The row-to-row connector portion 138 includes a flashing interface 68 and flashing walls 69 that prevent fluid from entering the photovoltaic array (not shown), and includes a connection recess 14. The flashing interface 68 and flashing walls 69 extend from the row-to-row connector portion 138 and partially around the overlap portion 66. An alignment rib 78 extends along a portion of the flashing walls 69 and assists in forming a connection with an adjacent photovoltaic component. An end of the flashing interface 68 includes a flashing extension 70. The overlap portion 66 receives a photovoltaic component and preferably a photovoltaic module (not shown) so that a connection member of the photovoltaic component forms a connection with the connection members 10 of the bottom right minus piece 126. The connection members 10 are connection recesses 14 that include walls 16 that extend around the connection recesses 14. The bottom right minus piece 126 has a width that is shorter than a standard width and is (Y⁻) and a height that is greater than a standard width and has a length (X⁺).

FIG. 15 illustrates a flashing piece 60 that is a row-to-row flashing piece 120. The row-to-row flashing piece 120 is a left piece 128. The left piece includes a row-to-row connector portion 138 that connects two adjacent rows together. The row-to-row connector portion 138 is connected to and includes both an overlap portion 66, a cap portion 72, and an alignment rib 78. The row-to-row connector portion 138 also includes a connection recess 14. The left piece connects two full rows together but extends between three rows. An overlap portion 66 of the row-to-row connector portion 138 extends under a first piece of a first row, the cap 72 of the row-to-row connection portion 138 and the overlap portion 66 are aligned in a second row, and the cap 72 connected to the overlap portion 66 extends over a piece in a third row. Connection recesses 14 extend through the left piece 128 for forming a connection with one or more adjacent components (not shown). Each of the connection recesses 14 are surrounded by a wall 16 that assists in preventing fluid from entering the connection recess 14.

FIG. 15A is a close-up view of the row-to-row connection portion 138 of FIG. 15. The row-to-row connection portion 138 includes a flashing interface 68 that is adjacent to a flashing wall 69 and an alignment rib 78 is located proximate to the top of the flashing wall 69, and includes a connection recess 14 having a wall 16. The alignment rib 78 assists in aligning two photovoltaic components together and preventing lateral movement of the photovoltaic components relative to each other.

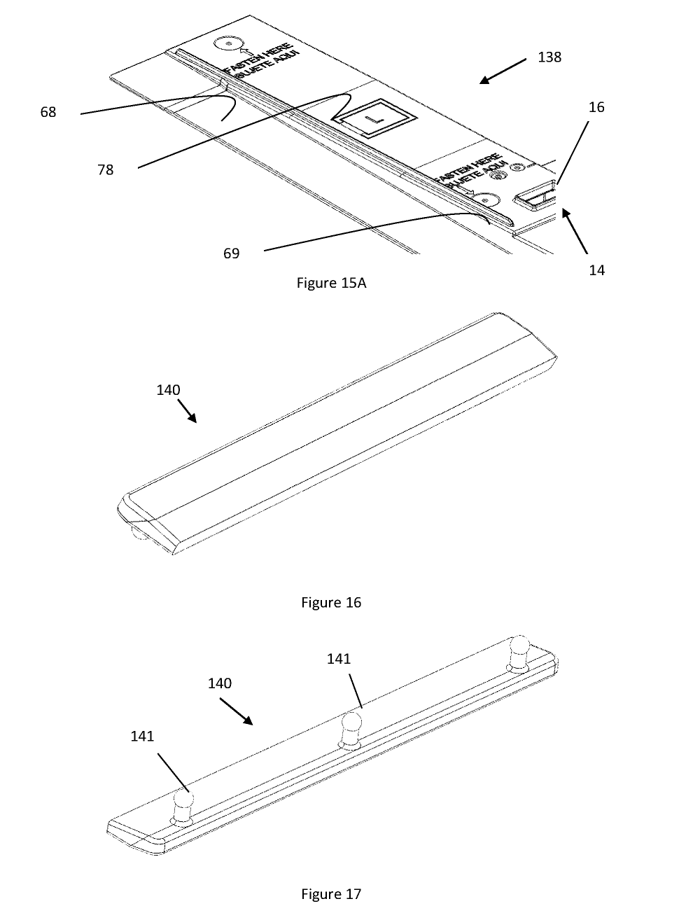

FIG. 16 illustrates a top perspective view of a door 140.

FIG. 17 illustrates a bottom perspective view of a door 140 including a plurality of spaced apart projections 141 that form a connection with a socket (not shown) of the opening (not shown).

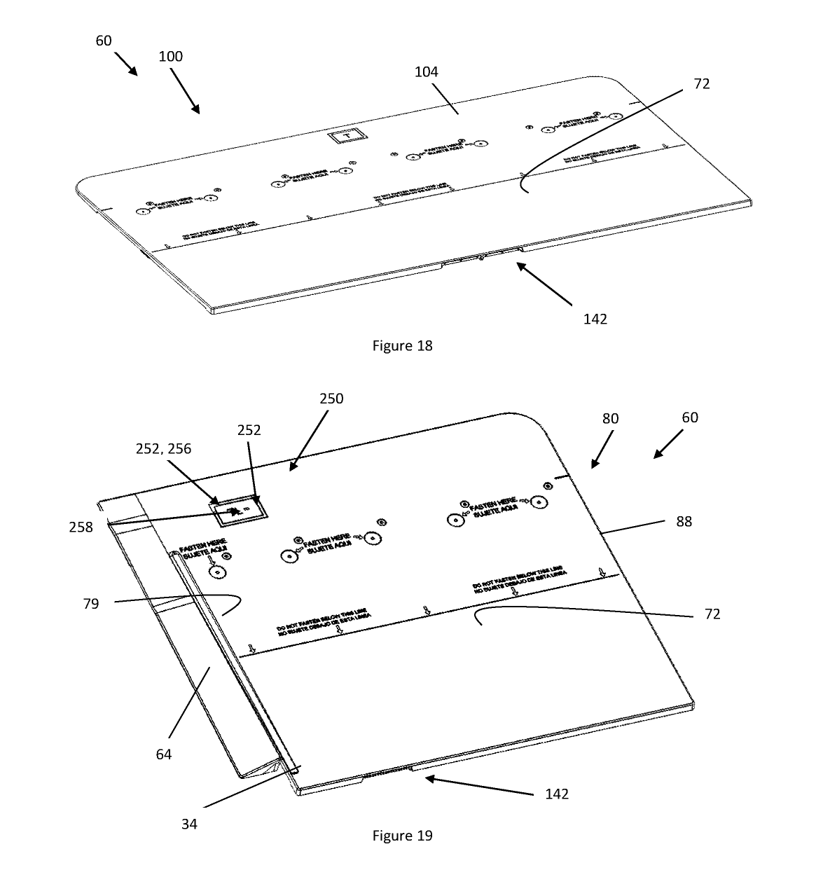

FIG. 18 illustrates a top perspective view of a flashing component 60 that is a center flashing piece 100 and is a top piece 104. The top piece 104 is a cap piece 72 that covers one or more adjacent photovoltaic components so that fluid flows down the photovoltaic array. The top piece 104 includes an opening 142 for exposing a portion of an adjacent photovoltaic component.

FIG. 19 illustrates a flashing component 60 that is a corner flashing piece 80. The corner flashing piece 80 is a top left minus piece 88 that is a cap portion 72 and extends over an adjacent photovoltaic component (not shown) forming a shingled section with no through holes for fluids to pass through. The top left minus piece 88 includes a side edge 34 with a side ledge 64 extending therefrom for forming an overlap with adjacent photovoltaic components or a shingle and for preventing fluid from extending onto the top left minus piece 88. A raised portion of an alignment slot 79 is located proximate to and extends along the side edge 34 and side ledge 64. A bottom edge 32 includes an opening 142. The top left minus piece 88 includes an installation indicator 250. The installation indicator 250 includes characters 252 that as shown are letters 256, which verbally describe the location of the flashing component 60 within a photovoltaic array. The installation indicator 250 also includes symbols 252 that indicate the width of the flashing component 60 relative to a standard component. The installation indicator 250 also includes highlighting 258 that visually depicts the location of the flashing component 60 within a photovoltaic array.

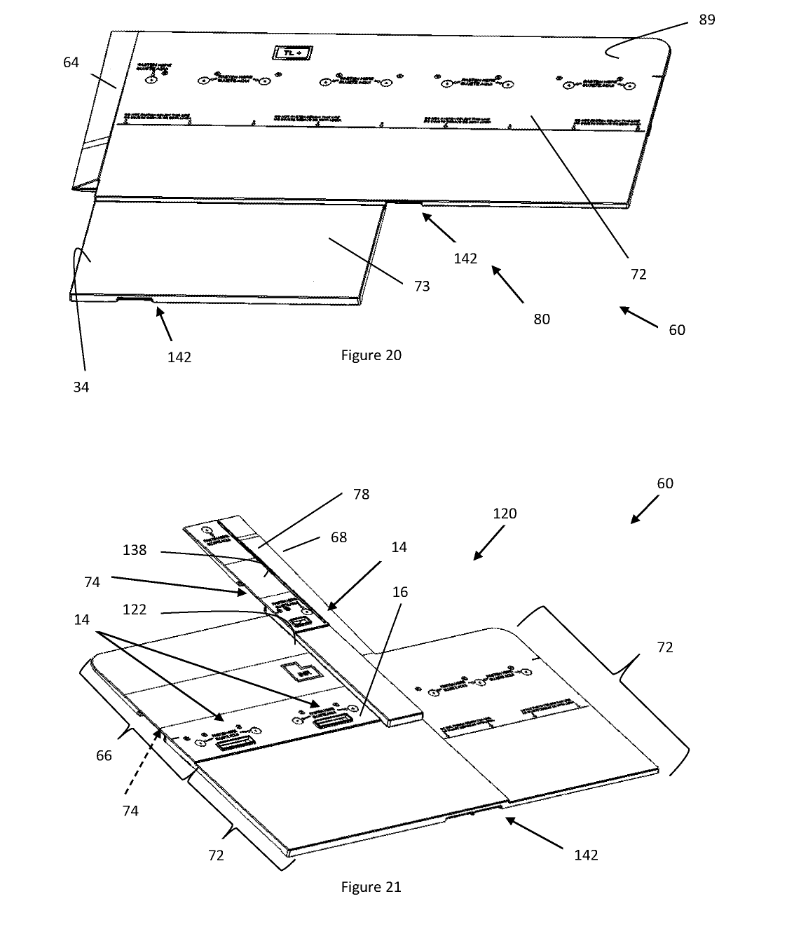

FIG. 20 illustrates a flashing component 60 that is a corner flashing piece 80. The corner flashing piece 80 is a top left plus piece 89. The top left plus piece 89 includes a cap portion 72 that extends over one or more photovoltaic components in a photovoltaic array (not shown). The cap portion 72 includes a side ledge 64 that forms a terminal edge. A cap extension 73 extends from the cap portion 72 an includes a side edge 34 that is free of a side ledge so that another component (not shown) that includes a side ledge can extend next to an under the cap extension 73. Both the cap extension 73 and the cap portion 72 include openings 142 for exposing a component (not shown) that is covered by the cap extension 73.

FIG. 21 illustrates a top perspective view of a flashing component 60 that is a row-to-row flashing piece 120. The row-to-row flashing piece 120 is a step-in right piece 122. The step-in right piece 122 includes two halves that are separated by a row-to-row connector portion 138 that includes a flashing interface 68 along one side and a connector channel 74 along an opposing side and an alignment rib 78 and connection recess 14 extending through a central portion. On a first side (e.g., right as shown) of the row-to-row connector portion 138 there is a cap portion 72 that extends over and covers one or more adjacent photovoltaic components so that fluid is prevents from extending through the photovoltaic components and a shingle effect is created. On the second side (e.g., left side as shown) of the row-to-row connector portion 138 there is partial cap portion 72 and overlap portion 66. The cap portion 72 includes an opening 142 that exposes an internal location of the step-in right piece 122 and may be closed by a door (not shown). The overlap portion 66 includes connection recesses 14 that are each surrounded by walls 16. An edge of the overlap portion 66 includes an opening for a connector channel 74 so that an electrical connection can be formed.

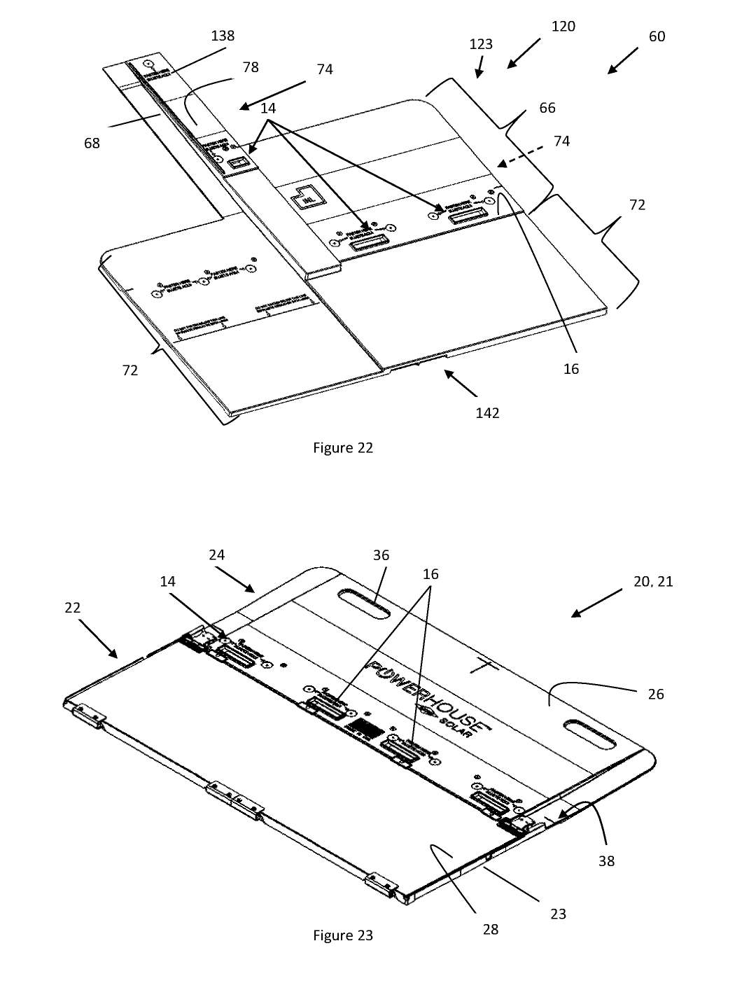

FIG. 22 illustrates a top perspective view of a flashing component 60 that is a row-to-row flashing piece 120. The row-to-row flashing piece 120 is a step-in left piece 123. The step-in left piece 123 includes two halves that are separated by a row-to-row connector portion 138 that includes a flashing interface 68 along one side and a connector channel 74 along an opposing side and an alignment rib 78 and connection recess 14 extending through a central portion. On a first side (e.g., left as shown) of the row-to-row connector portion 138 there is a cap portion 72 that extends over and covers one or more adjacent photovoltaic components so that fluid is prevents from extending through the photovoltaic components and a shingle effect is created. On the second side (e.g., right side as shown) of the row-to-row connector portion 138 there is partial cap portion 72 and overlap portion 66. The cap portion 72 includes an opening 142 that exposes an internal location of the step-in right piece 122 and may be closed by a door (not shown). The overlap portion 66 includes connection recesses 14 that are each surrounded by walls 16. An edge of the overlap portion 66 includes an opening for a connector channel 74 so that an electrical connection can be formed. The step-in left piece 123 is a mirror image of the step-in right piece 122 of FIG. 21.

FIG. 23 illustrates a top perspective view of an active component 20 that is a photovoltaic module 21. The photovoltaic module 21 includes an active portion 22 and an overlap portion 24. The active portion 22 includes a photovoltaic laminate 28 that generates power and the overlap portion 24 includes connection recesses 14 for forming a connection with an adjacent photovoltaic component (not shown). The photovoltaic laminate 28 is located on a support portion 23 that provides support to the photovoltaic laminate 28. The active overlap portion 24 includes handles 36 for carrying the photovoltaic module 21 and connector channels 38 that assist in forming a connection with a connector (not shown). Each of the connection recesses 14 include a wall 16 that extends around a periphery of the connection recess 14. The photovoltaic laminate 28 sits on top of a base plate 26.

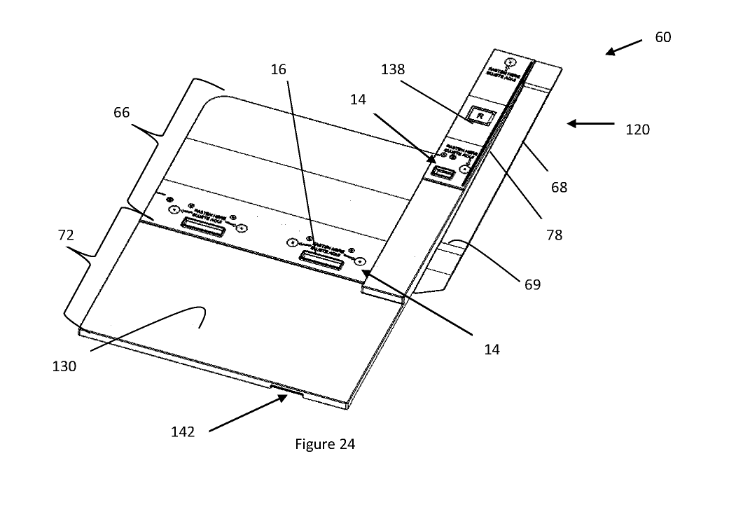

FIG. 24 illustrates a top perspective view of a flashing component 60 that is a row-to-row flashing piece 120. The row-to-row flashing piece 120 is a right piece 130. The right piece 130 includes a row-to-row connector portion 138 having a flashing interface 68 and a flashing wall 69 proximate to the flashing interface 68, and an alignment rib 78 extending along the row-to-row connector portion 138. The row-to-row connector portion 138 includes a connection recess 14. The row-to-row connector portion 138 is located between and connected to an overlap portion 66 and a cap portion 72. The overlap portion 66 includes connection recesses 14 that are surrounded by walls 16 so that fluid is prevented from flowing into the connection recesses 14. The cap portion 72 is located below the overlap portion 66 and the cap portion 66 includes an opening 142 along an edge.

Any numerical values recited herein include all values from the lower value to the upper value in increments of one unit provided that there is a separation of at least 2 units between any lower value and any higher value. As an example, if it is stated that the amount of a component or a value of a process variable such as, for example, temperature, pressure, time and the like is, for example, from 1 to 90, preferably from 20 to 80, more preferably from 30 to 70, it is intended that values such as 15 to 85, 22 to 68, 43 to 51, 30 to 32 etc. are expressly enumerated in this specification. For values which are less than one, one unit is considered to be 0.0001, 0.001, 0.01 or 0.1 as appropriate. These are only examples of what is specifically intended and all possible combinations of numerical values between the lowest value and the highest value enumerated are to be considered to be expressly stated in this application in a similar manner.

Unless otherwise stated, all ranges include both endpoints and all numbers between the endpoints. The use of “about” or “approximately” in connection with a range applies to both ends of the range. Thus, “about 20 to 30” is intended to cover “about 20 to about 30”, inclusive of at least the specified endpoints.

The disclosures of all articles and references, including patent applications and publications, are incorporated by reference for all purposes. The term “consisting essentially of” to describe a combination shall include the elements, ingredients, components or steps identified, and such other elements ingredients, components or steps that do not materially affect the basic and novel characteristics of the combination. The use of the terms “comprising” or “including” to describe combinations of elements, ingredients, components or steps herein also contemplates embodiments that consist essentially of the elements, ingredients, components or steps. By use of the term “may” herein, it is intended that any described attributes that “may” be included are optional.

Plural elements, ingredients, components or steps can be provided by a single integrated element, ingredient, component or step. Alternatively, a single integrated element, ingredient, component or step might be divided into separate plural elements, ingredients, components or steps. The disclosure of “a” or “one” to describe an element, ingredient, component or step is not intended to foreclose additional elements, ingredients, components or steps.

It is understood that the above description is intended to be illustrative and not restrictive. Many embodiments as well as many applications besides the examples provided will be apparent to those of skill in the art upon reading the above description. The scope of the teachings should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. The omission in the following claims of any aspect of subject matter that is disclosed herein is not a disclaimer of such subject matter, nor should it be regarded that the inventors did not consider such subject matter to be part of the disclosed inventive subject matter.

2 Photovoltaic Array

3 Irregular photovoltaic array

4 Rows

6 Peripheral edge

10 Connection member

12 Connection hook

14 Connection Recess

16 Wall around connection recess

17 Starter row

18 Internal row

19 Ending row

20 Active Component

21 Photovoltaic module

22 Active portion

24 Overlap portion

26 Base Plate

28 Pv Laminate

29 Peripheral edge

36 Handle

38 Connector channels

40 Connecter

60 Flashing Component

64 Side Ledges

66 Overlap portion

68 Flashing interface

69 Flashing Wall

70 Flashing extension

71 Pocket

72 Cap portion

73 Cap Extension

74 Connector Channel

76 Ribs

78 Alignment rib

79 Alignment Slot

80 Corner Flashing Piece

82 Top Right Minus

84 Top Right Plus Piece

86 Bottom Left Corner Positive Piece

88 Top Left Minus Piece

89 Top Left Plus Piece

90 Bottom right corner positive piece

100 Center Flashing Piece

102 Bottom

104 Top piece

120 Row-to-row flashing Piece

122 Step-in right piece

123 Step-in left piece

124 Bottom Left minus Piece

126 Bottom Right minus piece

128 Left piece

130 Right piece

138 Row-to-row connector portion

140 Cap

200 Alignment Feature

202 Horizontal Alignment Feature

204 Vertical Alignment Feature

250 Installation indicator

252 Character

254 Symbol

256 Letters

258 Highlighting

300 Right Step In

350 Left Step-out

400 Cut lines

410 space

1. A photovoltaic array comprising:
three or more overlapping rows of photovoltaic modules;
wherein at alternating ends, adjacent rows of photovoltaic modules are each interconnected by a row-to-row flashing piece; and
wherein a first end of a first row of photovoltaic modules extends a distance beyond a first end of a second row of photovoltaic modules, and a third row of photovoltaic modules and the second row of photovoltaic modules are in communication with one or more flashing components that extend the first end of the second row of photovoltaic modules at least the distance that the first end of the first row of photovoltaic modules extend; and
wherein the row-to-row flashing piece includes:
a row-to-row connector portion that extends from the first row to a top the second row or a top of the third row, and
a partial or full overlap portion on one or both sides of the row-to-row connector portion that receives a portion a photovoltaic module of the second row.

2. The photovoltaic array of claim 1, wherein one or more of the one or more flashing components that are in communication with the third row of photovoltaic modules and the second row of photovoltaic modules have a portion removed along a cut line so that the one or more flashing components mate with one of the row-to-row flashing piece.

3. The photovoltaic array of claim 1, wherein at least one of the row-to-row flashing pieces forms a cap over all or a portion of one or more photovoltaic modules within the three or more overlapping rows of photovoltaic modules and forms an overlap portion that supports all or a portion of one or more photovoltaic modules within a row of the three or more overlapping rows of photovoltaic modules.

4. The photovoltaic array of claim 1, wherein the distance that the first row of photovoltaic modules extend beyond the second row of photovoltaic modules and the third row of photovoltaic modules forms at least one step-in that includes:
at least one of the row-to-row flashing pieces is a step-in piece and each of the one or more step-in pieces include:
(i) the row-to-row connector portion and
(ii) the partial or full overlap portion on one or both sides of the row-to-row connector portion; or
(iii) a partial or full cap portion on one or both sides of the row-to-row connector portion; or
(iv) the partial or full overlap portion on one side of the row-to-row connector portion and a partial or full cap portion on an opposing side of the row-to-row connector portion; and
wherein one or more photovoltaic modules in the second row of photovoltaic modules extends at least partially over the overlap portion on one side of the row-to-row connector portion.

5. The photovoltaic array of claim 4, wherein the at least one step-in is on the right side of the photovoltaic array, on the left side of the photovoltaic array, or both the left side and the right side, and the partial or full overlap portion is at least partially covered by one of the photovoltaic modules of the second row of photovoltaic modules.

6. The photovoltaic array of any of claim 4, wherein the row-to-row flashing piece includes the full cap portion on one side of the row-to-row connector portion and a partial overlap portion and partial cap portion on the opposing side of the row-to-row connector portion.

7. The photovoltaic array of claim 1, wherein the distance that the first row of photovoltaic modules extend beyond the second row of photovoltaic modules and the third row of photovoltaic modules forms at least a step-out that includes:
one or more of the row-to-row flashing pieces; and
one or more of the one or more flashing pieces are one or more corner flashing pieces, one or more center flashing pieces, or both that directly connect to at least one of the row-to-row flashing piece; and
wherein the one or more corner flashing pieces, the one or more center flashing pieces, or both include a removable portion that when removed forms a cut corner flashing piece, a cut center flashing piece, or both so that the cut corner flashing piece, the cut center flashing piece, or both forms the direct connection with the row-to-row flashing piece.

8. The photovoltaic array of claim 7, wherein the step-out is on the right side of the photovoltaic array, on the left side of the photovoltaic array, or both; the cut corner flashing piece, the cut center flashing piece, or both are at least partially covered by one or more photovoltaic modules of the three or more rows of photovoltaic modules; or both.

9. The photovoltaic array of claim 7, wherein the cut corner flashing piece contacts and extends under one of the one or more row-to-row flashing piece on one end of the cut corner flashing piece, and the cut corner flashing piece extends over a portion of another of the one or more row-to-row flashing piece at an opposing end of the cut corner flashing piece.

10. The photovoltaic array of claim 1, wherein the row-to-row flashing piece includes one or more connection hooks, one or more connection recesses, or both and the one or more connection hooks, one or more connection recesses, or both connect the row-to-row flashing piece to one or more photovoltaic modules.

11. A method for forming the photovoltaic array of claim 7 comprising:
forming the three or more rows of photovoltaic modules;
terminating at least one of the three or more rows of photovoltaic modules with the row-to-row flashing piece;
overlapping the row-to-row flashing piece on an inside edge at least partially with a photovoltaic component of one of the three or more rows;
connecting a flashing component to the row-to-row flashing piece on an outside edge so that the flashing component extends beyond at least one of the three or more rows of flashing components; and
applying one or more rows of stepped-out photovoltaic modules that have a portion that extends over the flashing component that extends beyond the one or more rows of flashing components so that the at least a portion of the one or more rows of stepped-out photovoltaic modules extend beyond the at least one of the three or more rows of photovoltaic modules that are terminated.

12. The method of claim 11, further comprising cutting one or both sides of the flashing component that extends beyond the one or more rows of photovoltaic modules that are terminated before the flashing component is connected to the row-to-row flashing piece.

13. The method of any of claim 11, further comprising, applying a stepped-out row-to-row flashing piece (120) to an end of the one or more rows of stepped-out photovoltaic modules.

14. A method for forming the photovoltaic array of claim 4 comprising:
forming one or more rows of photovoltaic modules;
capping a portion of a top row of the one or more rows of photovoltaic modules; and
applying one or more stepped-in rows of photovoltaic modules over the top row of the one or more rows of the three or more overlapping rows of photovoltaic modules and terminating the stepped-in rows of photovoltaic modules at the portion of the top row that is capped so that a space is formed above the partial capped portion of the one or more rows of photovoltaic modules.

15. The method of claim 14, further comprising capping the portion of the top row with a row-to-row flashing piece that is a step-in piece and electrically connecting the top row to at least one of the one or more stepped-in rows of photovoltaic modules.
